(19) United States
(12) Patent Application Publication
(10) Pub. No.: US 2003/0046220 A1
(43) Pub. Date: Mar. 6, 2003

(54) Apparatus, method and program for supporting trade transaction

(76) Inventor: Tadashi Kamiya, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/222,826

(22) Filed: Aug. 19, 2002

(30) Foreign Application Priority Data
Aug. 31, 2001 (JP) 2001-262892

(51) Int. Cl. G06F 17/60

(52) U.S. Cl. 705/37

(57) ABSTRACT

A system for supporting trade transactions includes a server, a supplier client and a buyer client interconnected by a network. The server forecasts future quantity of sales by the buyer on a per-product basis based upon performance of sales to a customer by the buyer with regard to each product of a plurality of types and, based upon the forecast future sales quantity of every product, decides types of products and quantities thereof that the supplier is to export to the buyer. The forecast future sales quantity of every product and the decided types of products and quantities thereof to be exported are displayed on a display screen of the supplier client and/or buyer client.

### BACKGROUND OF THE INVENTION

1. Field of the Invention

This invention relates to an apparatus, method and program for supporting trade transactions.

2. Description of the Related Art

At locations where trade-related transactions are carried out, when the supplier (inclusive of an individual or legal person supplying a product) and the buyer (a user or purchaser of a product) are situated at physically remote locations (e.g., in two different countries), the supplier exports the product to the buyer and the buyer imports the product. The product imported by the buyer is sold to a customer (consumer). (In this sense, the buyer can also be referred to as a seller.) In accordance with an ordinary trading model, export of a product by a supplier is performed in response to outright purchase of the product by a buyer. In order to realize immediate delivery in response to an order from a customer who is the ultimate consumer, the buyer must keep the product in stock. The supplier, on the other hand, can collect payment when a product is shipped (exported). Products laid in stock (imported) by the buyer, however, become buyer inventory and the buyer cannot collect payment for them until they are sold to a customer. Hence the buyer is required to have the funds necessary to hold a product in inventory from outright purchase of the product to sale of the product.

There is a trading model in which the supplier entrusts the sales of a product to the buyer. According to this trading model, the supplier exports the product to the buyer in advance. The right of ownership of the product imported by the buyer remains with the supplier (the product is the supplier's stock). In other words, by placing the inventory at the place of final consumption, immediate delivery can be made to the customer, who is the end user, and loss of business opportunities can be eliminated. Further, since the moment a product is sold by the buyer can be made the moment the product is laid in stock, the buyer need not have company inventory of its own. This means that the buyer need not have funds to bear the cost of inventory. The supplier, however, collects payment when the buyer lays the product in stock (i.e., when the product is sold to the buyer). Hence it is necessary for the supplier to have the funds for bearing the cost of inventory from export of the product to sale of the product.

### DISCLOSURE OF THE INVENTION

Accordingly, the inventor has proposed a new trading model in which a supplier entrusts sale of a product to a buyer and employs a standby letter of credit. According to this trading model, the supplier exports the product to the buyer in advance in order to realize immediate delivery in response to an order from a customer who is the end user. Furthermore, the buyer establishes a standby letter of credit. According to the model, the supplier bears the expense of inventory from export of the product to the sale thereof but is capable of raising the inventory funds by the standby letter of credit and can receive debt reimbursement. Though a security deposit for establishing the standby letter of credit is necessary on the part of the buyer, it is as though the buyer comes to possess inventory with less funds than would otherwise be required for bearing the inventory. This model makes possible immediate delivery to a customer, i.e., the end user, eliminates loss of business opportunities and provides a competitive edge over competing sellers. In other words, the model makes it possible to achieve trade transactions that are advantageous for both the supplier and buyer.

An object of the present invention is to provide an apparatus, method and program for supporting trade transactions in such a manner that a supplier and buyer who engage in trade transactions, especially the above-described trade transactions, can do so in smooth fashion.

Another object of the present invention is to provide a program that enables an apparatus and method that support trade transactions to be implemented using a general-purpose computer, as well as a recording medium on which this program is recorded. The program recording medium can be not only a recording medium such as a floppy disk or CD-ROM but also a hard disk, magnetic tape or semiconductor memory.

An apparatus for supporting trade transactions according to a first aspect of the present invention is for supporting trade transactions between a supplier who exports a product and a buyer who sells the imported product to a customer. The apparatus comprises forecasting means for forecasting future quantity of sales by the buyer on a per-product basis based upon performance of sales to a customer by the buyer with regard to each product of a plurality of types; first display data creating means for creating data for displaying the future sales quantity of every product forecast by the forecasting means; export planning means for deciding types of products and quantities thereof, which the supplier is to export to the buyer, based upon the future sales quantity of every product forecast by the forecasting means; and second display data creating means for creating data for displaying the types of products and quantities thereof to be exported decided by the export planning means.

A method of supporting trade transactions according to the first aspect of the present invention is a method of supporting trade transactions between a supplier who exports a product and a buyer who sells the imported product to a customer. The method comprises the steps of forecasting future quantity of sales by the buyer on a per-product basis based upon performance of sales to a customer by the buyer with regard to each product of a plurality of types; creating data for displaying the forecast future sales quantity of every product; deciding types of products and quantities thereof, which the supplier is to export to the buyer, based upon the forecast future sales quantity of every product; and creating data for displaying the decided types of products and quantities thereof to be exported.

A first program according to the present invention is for controlling a computer that supports trade transactions between a supplier who exports a product and a buyer who sells the imported product to a customer. The program causes a computer to execute forecast processing for forecasting future quantity of sales by the buyer on a per-product basis based upon performance of sales to a customer by the buyer with regard to each product of a plurality of types; first display data creation processing for creating data for displaying the forecast future sales quantity of every product; export planning processing for deciding types of products and quantities thereof, which the supplier is to export to the buyer, based upon the forecast future sales quantity of every product; and second display data creation processing for creating data for displaying the decided types of products and quantities thereof to be exported.

In another manner of speaking, the quantity of sales of a product by a buyer is the quantity demanded by the customers who purchase the product sold by the buyer.

The trend of sales of each product is forecast from the type of the product and the quantity thereof (the sales performance) sold to customers by the buyer. For example, an equation representing a regression line, a regression quadratic curve or a regression exponential curve is obtained from the sales performance, and future sales quantity is found based upon the equation obtained.

Since future quantity of sales of a product by a buyer is forecast, the type of product and the quantity thereof to be exported to the buyer from the supplier are decided based upon the results of the forecast. With regard to export quantity, the total quantity of supplier inventory regarding the product to be exported (the supplier inventory relates to a product that is under the management of the buyer and, moreover, is in the ownership of the supplier), buyer inventory (inventory of a product whose right of ownership has been transferred from the supplier to the buyer) and in-transit inventory (inventory of a product currently being transported by ship or air) is decided in such a manner that it will not fall below a fixed value (a predetermined quantity) (i.e., in such a manner that the total quantity will not become less than the predetermined quantity). Supplier inventory and buyer inventory is the quantity of products that the buyer can deliver to a customer immediately; in-transit inventory is a quantity of products for which a prompt answer (of delivery date) can be given. The sum total of these inventory quantities is referred to as the “available-to-promise quantity”.

Data for displaying the forecast future sales quantity of every product (data for displaying the results of the forecast) is created and so is data for displaying the decided types of products and quantities thereof to be exported (data for displaying the export plan). The results of the forecast and the export plan can therefore be displayed on a display screen.

In a trade transaction in which a supplier exports a product to a buyer in advance so that immediate delivery to customers can be made and supplier inventory quantity, buyer inventory quantity and in-transit inventory quantity (the total of which is the available-to-promise quantity) are managed in such a manner that a customer can be given a prompt answer concerning delivery date of the product, it is necessary for the supplier to consider which type of product and the quantity thereof (how many) is to be exported to the buyer. According to the present invention, the future quantity of sales of every product by the buyer is forecast based upon the buyer's sales performance (actual past sales quantity of each product). Hence there is little possibility that results of the forecast will be far off the mark. Which type of product and the quantity thereof should be exported (i.e., whether the available-to-promise quantity can be acquired) can be decided based upon the results of the forecast. The possibility that too large a quantity of a product will be exported needlessly or that so small a quantity of a product is exported that supplier inventory runs out can be diminished. Thus the supplier can export the appropriate quantity of a product.

Of course, it may be so arranged that the future quantity of sales of every product (the results of the forecast), the decided type of product and the quantity thereof to be exported (the export plan) use values revised by the operator of a client computer. In a case where the result of a forecast is revised, the type of a product and the quantity thereof to be exported are decided based upon the revised forecast result. If a decided type of product and the quantity thereof to be exported are revised, then the revised value is treated as the new export plan.

A prediction of future sales quantity of every product is a particularly important factor in a trade transaction in which a supplier exports a product to a buyer in advance. The reason for this is as follows: When a ship is used to transport a product, there are instances where transport is performed at a regular cycle (a shipping cycle) (e.g., one shipment per month). In such case, it is required that the available-to-promise quantity for a scheduled export date (scheduled shipping date) be forecast beforehand and that the quantity of the product shipped be decided. Preferably, the apparatus for supporting trade transactions is provided with predicted available-to-promise quantity calculation means for calculating the available-to-promise quantity at a scheduled export date by the supplier. The quantity of a product to be exported is calculated in such a manner that the available-to-promise quantity at a scheduled export date calculated by the predicted available-to-promise quantity calculation means will not fall below a predetermined inventory quantity (a predetermined quantity). As a result, the quantity of a product to be exported can be decided based upon the shipping cycle time and sales forecast during this period of time.

An apparatus for supporting trade transactions according to a second aspect of the present invention is for supporting trade transactions between a supplier who exports a product and a buyer who sells the imported product to a customer. The apparatus comprises storage means for storing quantity, supplier buy-up request intent data and buyer buy-up intent data of each product in supplier inventory, which is inventory regarding a product for which import by the buyer has been completed and which is in the ownership of the supplier; determination means for determining whether the total monetary amount of a product of the supplier inventory is greater than a predetermined limit amount; buy-up product decision means which, if the determination means has determined that the total monetary amount of a product of the supplier inventory is greater than the limit amount, is for deciding a product and the quantity thereof that the buyer is to be made to buy in such a manner that a buy-up amount of the product by the buyer will become equal to or greater than an amount obtained by subtracting the limit amount from the total monetary amount of the product, this decision being rendered based upon the supplier buy-up request intent data and buyer buy-up intent data; and display data creation means for creating data for displaying the type of product and quantity thereof decided by the buy-up product decision means.

A method of supporting trade transactions according to the second aspect of the present invention is a method of supporting trade transactions between a supplier who exports a product and a buyer who sells the imported product to a customer. The method comprises the steps of storing quantity, supplier buy-up request intent data and buyer buy-up intent data of each product in supplier inventory, which is inventory regarding a product for which import by the buyer has been completed and which is in the ownership of the supplier; determining whether the total monetary amount of a product of the supplier inventory is greater than a predetermined limit amount; if it has been determined that the total monetary amount of a product of the supplier inventory is greater than the limit amount, deciding a product and the quantity thereof that the buyer is to be made to buy in such a manner that a buy-up amount of the product by the buyer will become equal to or greater than an amount obtained by subtracting the limit amount from the total monetary amount of the product, this decision being rendered based upon the supplier buy-up request intent data and buyer buy-up intent data; and creating data for displaying the type of product and quantity thereof decided.

In a case where a standby letter of credit is utilized, a reimbursement amount (the limit amount) is written in the standby letter of credit. If the total monetary amount of a product in supplier inventory falls within the limit amount, the supplier can receive reimbursement from a bank. If the total amount of a product in supplier inventory exceeds the limit amount, however, the amount of excess is not guaranteed. According to the second aspect of the present invention, if the total monetary amount of a product in supplier inventory exceeds the limit amount, processing for having the buyer buy up the product in an amount commensurate with the amount of excess is executed.

In accordance with the present invention, it is determined whether the total monetary amount of a product in supplier inventory exceeds a predetermined limit amount. If it has been determined that the total monetary amount of a product in supplier inventory has exceeded the limit amount, then a product and the quantity thereof that the buyer is to be made to buy are decided, based upon supplier buy-up request intent data and buyer buy-up intent data, in such a manner that a buy-up amount of the product by the buyer will become equal to or greater than an amount obtained by subtracting the limit amount from the total monetary amount of the product. Thus the product and the quantity thereof that the buyer is to be made to buy are decided upon taking into consideration the intent of the buyer and the intent of the supplier.

In processing for deciding a product to be bought up, it will suffice if a decision concerning the type of a product and the quantity thereof based upon buyer buy-up intent data and a decision concerning the type of a product and the quantity thereof based upon supplier buy-up request intent data are performed alternatingly. It is possible to repeat processing that involves deciding a buy-up product (a product that the buyer is to be made to purchase outright) and quantity thereof that take buyer intent into consideration and then deciding a buy-up product that takes supplier intent into consideration. As a result, a buy-up product can be decided so as to obtain the consent of both the buyer and supplier.

It is assumed that the buyer buy-up intent data and supplier buy-up request intent data be that of a product having the highest available-to-promise number of turns in the supplier inventory, a product having the highest gross margin, a product providing the highest revenue or a product having the highest number of turns in supplier inventory. If the buyer buy-up intent data is a “product having the highest available-to-promise number of turns in the supplier inventory”, then a product having the highest available-to-promise number of turns in the supplier inventory is decided on as the buy-up product in buy-up product decision processing based upon the buyer buy-up intent data. If the supplier buy-up request intent data is a “product having the highest gross margin”, then a product having the highest gross margin is decided on as the buy-up product in buy-up product decision processing based upon the supplier buy-up request data.

A method of performing trade transaction in accordance with the present invention may be comprehensively defined as follows.

A method of performing trade transaction comprises the steps of placing a product, which is exported by the supplier and imported by the buyer, under the management of the buyer with ownership of the product being retained by the supplier; and based upon the standby letter of credit issued in accordance with a request from the buyer, having the supplier raise funds needed to keep in inventory a product that is under the management of the buyer.

A method of performing trade transaction in accordance with the present invention may be expressed more concretely as follows;

A product exported by the supplier of a first country is imported by the buyer of a second country. With regard to a product exported to the second country by the supplier and imported from the first country by the buyer, the product placed under the management of the buyer with ownership of the product being retained by the supplier. The buyer requests a collection bank of the second country to issue a standby letter of credit, and the collection bank of the second country that has received the request for issuance of the standby letter of credit requests a reimbursing bank of the second country to issue the standby letter of credit. The reimbursing bank of the second country that has issued the standby letter of credit forwards the standby letter of credit to a negotiating bank of the first country and notifies the supplier of the content of the standby letter of credit. In accordance with credit based upon the standby letter of credit, the supplier borrows, from the negotiating bank of the first country, the funds needed to keep in inventory a product that is under the management of the buyer. The supplier can raise the funds needed for inventory and can receive debt reimbursement by the standby letter of credit. Though a security deposit for establishing the standby letter of credit is necessary on the part of the buyer, it is as though the buyer comes to possess inventory with less funds than would otherwise be required for bearing the inventory. This method makes possible immediate delivery to a customer, i.e., the end user, eliminates loss of business opportunities and provides a competitive edge over competing sellers.

In accordance with this method of performing trade transactions, the right of ownership of a product, which is under the management of the buyer and the right of ownership of which is held by the supplier, is transferred from the supplier to the buyer, and the buyer responds to an order from a customer by selling to the customer the product whose right of ownership has been transferred to the buyer.

Preferably, a computer manages the total of the stock of every type of product, which is under the management of the buyer and the right of ownership of which is held by the supplier, the stock of every type of product, which is under the management of the buyer and the right of ownership of which is held by the buyer owing to transfer of the right of ownership, and the number of every type of product currently in transit from the supplier to the buyer. An immediate answer regarding delivery can be given in response to a customer request or inquiry.

In an embodiment, the method further comprises the steps of forecasting future sales quantity of every type of product based upon results of sales of the product to customers by the buyer; and deciding the type of product and the quantity thereof is supplied to the buyer from the supplier, in accordance with the total of stock of every type of product, which is under the management of the buyer and the right of ownership of which is held by the supplier, stock of every type of product, which is under the management of the buyer and the right of ownership of which is held by the buyer owing to transfer of the right of ownership, the number of every type of product currently in transit from the supplier to the buyer, and the forecasted future sales quantity of every product to be sold by the buyer. The supplier can stabilize (equalize) production (supply, export) of the products by forecasting beforehand future sales quantity of every type of product, and managing various inventory quantity. Further products are exported from the supplier to the buyer based on the forecasted sales quantity and various inventory quantity, so that the buyer does not lose a sales opportunity of a product to a customer.

The supplier may use a computer to forecast the future sales quantity of every product based upon results of sales of the product to customers by the buyer, and may decide by computer the type of product and the quantity thereof to be exported, taking into consideration the sales quantity obtained by the forecast.

In another embodiment, if the monetary amount of a product the right of ownership of which is held by the supplier and that is under the management of the buyer exceeds the amount that can be borrowed on the standby letter of credit, the supplier requests the buyer to buy the product in an amount commensurate with the excess. In this case, it will be good to decide the type of product and the quantity thereof to be bought up by the buyer taking into consideration the opinions of both the supplier and buyer.

In still another embodiment, the method further comprises a step of disclosing on computers owned by the supplier and the buyer the total of stock of every type of product, which is under the management of the buyer and the right of ownership of which is held by the supplier, stock of every type of product, which is under the management of the buyer and the right of ownership of which is held by the buyer owing to transfer of the right of ownership, the number of every type of product currently in transit from the supplier to the buyer, the forecasted future sales quantity of every type of product to be sold by the buyer, and the decided type of product and the quantity thereof is supplied from the supplier to the buyer. The supplier and the buyer can share the information about the product.

Further, the present invention provides a trade transaction support system that utilizes a server (a server computer) and a client (a client computer) connected to each other via a network, the server, the client and methods of controlling the system, server and client.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates the positioning of a supplier and buyer in international trade;

FIG. 2 illustrates the agents that take part in international trade and the flow of dealings involving various documents and products among the agents;

FIG. 3 illustrates the agents that take part in international trade and the flow of payment and collection of fees among the agents;

FIG. 4 is a block diagram illustrating the overall configuration of a system for supporting trade transactions;

FIG. 5 is a block diagram illustrating the hardware of a server computer;

FIG. 6 illustrates various tables stored in a hard disk of the server computer;

FIG. 7 illustrates various tables stored in a hard disk of the server computer;

FIG. 8 shows various programs stored in a hard disk of the server computer;

FIG. 9 is a block diagram showing the corresponding relationship of processing operations based upon the various programs;

FIG. 10 is a flowchart illustrating the flow of forecast processing;

FIG. 11 illustrates an example of a forecast planning screen;

FIG. 12 illustrates an example of a product master;

FIG. 13 illustrates an example of a sales table and sales planning table;

FIG. 14 illustrates an example of a sales history table;

FIG. 15 illustrates an example of a forecast table;

FIG. 16 is a flowchart illustrating the flow of processing for planning shipping;

FIG. 17 illustrates an example of a shipping schedule/parameter screen;

FIG. 18 shows the manner in which errors are displayed on a shipping planning screen;

FIG. 19 illustrates an example of a shipping plan screen;

FIG. 20 illustrates an example of the shipping schedule screen;

FIG. 21 shows an example of a parameter table;

FIG. 22 shows an example of a shipping planning table and a shipping planning details table;

FIG. 23 is a flowchart illustrating the flow of shipping processing;

FIG. 24 shows an example of a shipping screen;

FIG. 25 shows an example of an invoice table and invoice details table;

FIG. 26 shows an example of an option table;

FIG. 27 shows an example of a table of daily inventory status;

FIG. 28 is a flowchart illustrating the flow of acceptance processing;

FIG. 29 shows an example of an acceptance screen;

FIG. 30 shows an example of a loans table and loans details table;

FIG. 31 is a flowchart illustrating the flow of buy-up request processing;

FIG. 32 shows an example of a buy-up request screen;

FIG. 33 shows an example of a buy-up request table and buy-up request details table;

FIG. 34 shows an example of an inventory statistics table;

FIG. 35 is a flowchart showing the flow of stock lay-in processing;

FIG. 36 shows an example of a stock lay-in screen;

FIG. 37 shows an example of a stock lay-in table and stock lay-in details table;

FIG. 38 is a flowchart showing the flow of sales processing;

FIG. 39 shows an example of a received-order and sales screen;

FIG. 40 shows another example of a received-order and sales screen;

FIG. 41 is a flowchart showing the flow of finance processing; and

FIG. 42 shows an example of a financing screen.

### DESCRIPTION OF THE PREFERRED EMBODIMENTS

Preferred embodiments of the present invention will now be described in detail with reference to the drawings.

1. Mode of International Trade

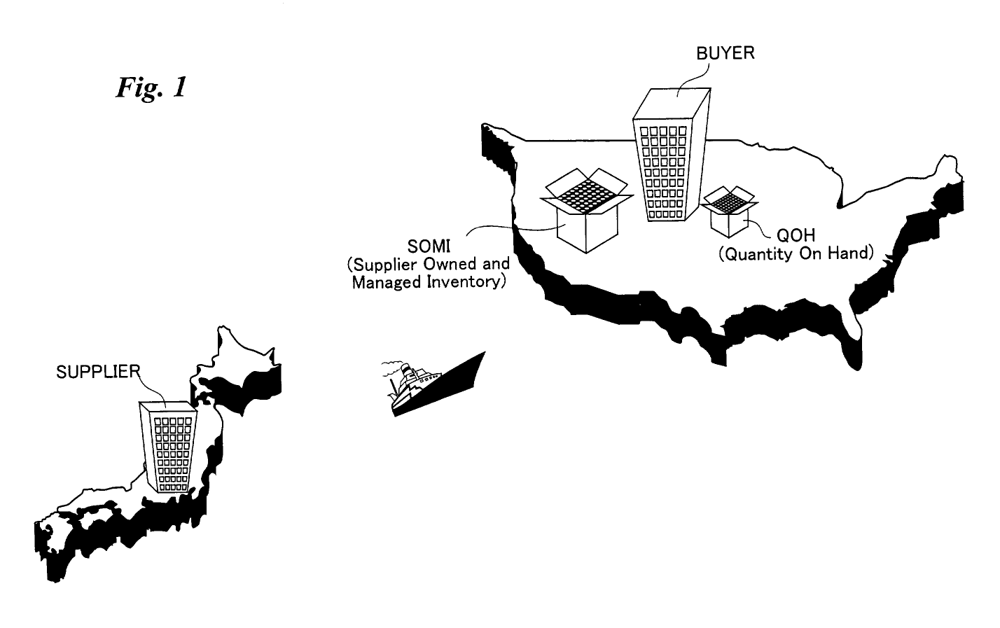

FIG. 1 illustrates an example of the positioning a supplier and buyer in international trade.

In international trade, such factors as the quality, quantity, price, time of delivery and payment conditions of traded products (parts) are agreed upon by a sales contract between a supplier (exporter or export agent) and a buyer (importer or import agent). The supplier exports the product to the buyer by sea or by air based upon the sales contract. The buyer imports the product exported by the supplier and pays the price of the imported product to the supplier based upon the sales contract. The supplier and buyer are individuals who engage in trade transactions between two countries, by way of example.

A mode of physical distribution used in international trade is to place a product, which is provided by the supplier, in the possession of the buyer while the right of ownership of the product remains with the supplier. Inventory of a product placed in the possession of the buyer in such case is referred to as Supplier Owned and Managed Inventory (referred to as “SOMI” below). By contrast, inventory of a product the right of ownership of which is held by the buyer is referred to as Quantity On Hand (referred to as “QOH below).

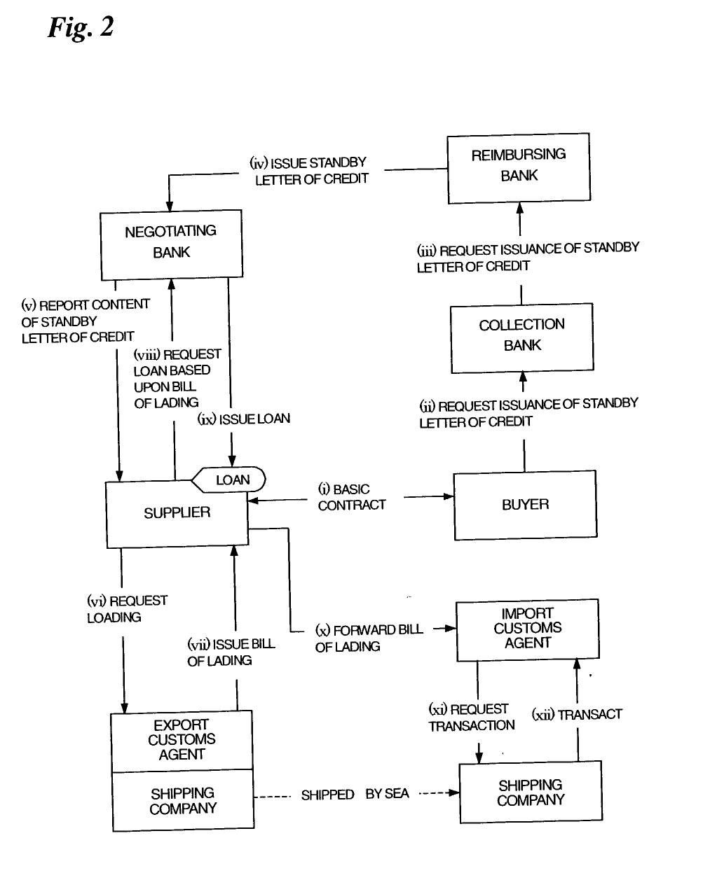

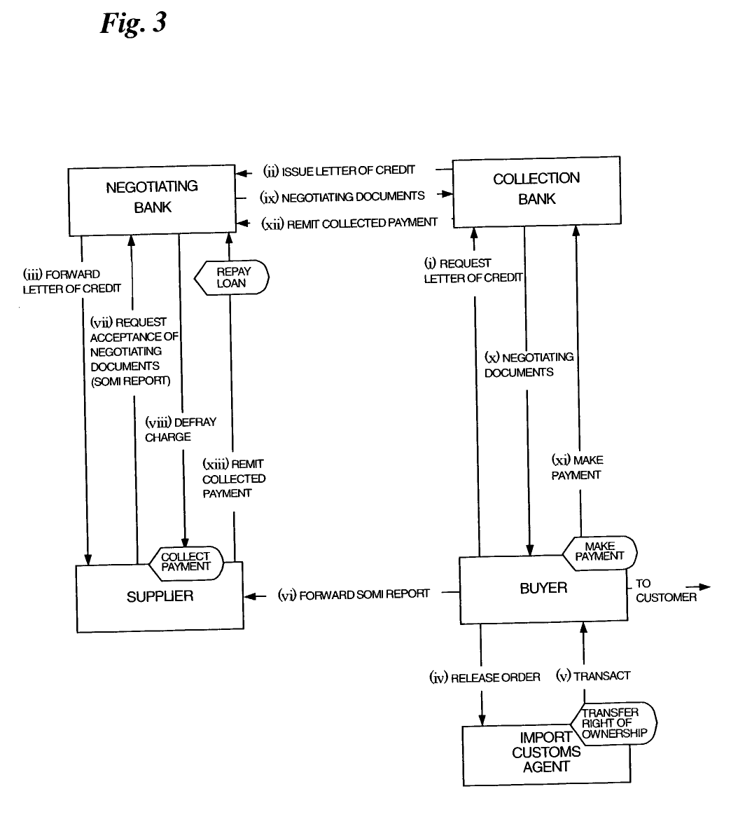

FIG. 2 illustrates an example of agents that take part in international trade utilizing SOMI and the flow of dealings involving documents (inclusive of letter of credit) and products among the agents. FIG. 3 illustrates an example of the relationship among the agents, with the focus being placed on collection of fees. FIG. 2 will be described first.

(i) On the assumption that a transaction will be made, a sales contract that decides such factors as the, traded product, its quality, quantity, price, delivery date and payment conditions is concluded between the supplier and the buyer.

(ii) In accordance with a product transaction utilizing SOMI, the product inventory is placed in the possession of the buyer, as mentioned above. In order to obtain security from loss in case of non-fulfillment of the contract by the buyer, therefore, the supplier requires the buyer to provide a bank guarantee. The buyer requests a collection bank to issue a standby letter of credit in which the content of the guarantee is written.

(iii) The collection bank requests a reimbursing bank to issue the standby letter of credit.

(iv) The reimbursing bank issues the standby letter of credit and forwards the issued standby letter of credit to a negotiating bank.

(v) The negotiating bank that has received the standby letter of credit notifies the supplier of the content of the standby letter of credit.

(vi) After confirming the content of the standby letter of credit, the supplier requests an export customs broker on the side of the port of lading to load a ship with the product (in case of conveyance by ship).

(vii) The product is delivered from the supplier to the export customs broker, after which the product is loaded onto the ship by the shipping company at the lading port. A bill of lading is issued from the shipping company to the export customs broker.

(viii) The bill of lading is forwarded from the export customs broker to the supplier. The supplier submits shipping documents, which include the bill of lading, to the negotiating bank and applies for a loan to make the payment.

(ix) The negotiating bank lends the money (the payment for the product) to the supplier based upon the standby letter of credit issued in response to the request from the buyer.

(x) The supplier further forwards the shipping documents, which include the bill of lading, to an import customs broker on the side of the unloading port in advance.

(xi) When the product that has been loaded on the ship is transported by the shipping company, arrives at the unloading port and is unloaded, the import customs broker complies with the customs proceedings for the unloaded product on the basis of the shipping documents sent beforehand by the supplier. The import customs broker requests the shipping company for permission to take charge of the unloaded product in exchange for the bill of lading included in the shipping documents.

(xii) The import customs agent takes charge of the product from the shipping company.

The product taken charge of by the import customs agent is stored in a warehouse that is agreed upon by the supplier and buyer and that is managed by a warehouse manager. The right of ownership of the product stored in the warehouse still resides with the supplier, and the product is applied as the product in SOMI. The business of managing the product in SOMI is performed by the supplier or buyer, depending upon the sales contract.

A letter of credit different from the standby letter of credit is used for collection of payment (FIG. 3) by the supplier from the buyer.

(i) The buyer requests the collection bank to issue a letter of credit.

(ii) The collection bank issues the letter of credit and forwards the issued letter of credit to the negotiating bank.

(iii) The negotiating bank forwards the received letter of credit to the supplier.

(iv) The buyer issues a release order and forwards it to the warehouse manager.

(v) The product described in the release order is sent from the warehouse manager to the buyer.

The right of ownership of the product is transferred from the supplier to the buyer. The status of the product accepted by the buyer changes from SOMI to QOH.

(vi) The buyer who has received the product sends the supplier a document (SOMI report) describing the type and quantity of the product received.

(vii) When the supplier presents the negotiating bank with the necessary documents (negotiating documents) inclusive of the SOMI report received from the buyer, (viii) the negotiating documents inclusive of the SOMI report are negotiated by the negotiating bank and the bank pays the supplier the fee for the product now in the possession of the buyer. The supplier collects the payment.

(ix) The negotiating bank that negotiated the SOMI report forwards the collection bank the negotiating documents inclusive of the SOMI report.

(x) The negotiating documents are submitted to the buyer by the collection bank and (xi) the buyer pays the collection bank the product purchase fee based upon the negotiating documents.

(xii) The collection bank remits the collected payment from the buyer to the negotiating bank.

(ix) Processing for repayment of the money lent to the supplier is performed between the supplier and the negotiating bank.

Though the business develops by virtue of the participation of the various banks, the export agents and the shipping company, etc., as described above, the actual transaction utilizing SOMI (QOH) and the standby letter of credit basically is a commercial transaction between the supplier and the buyer. The system for supporting a trade transaction described below mainly assists a trade transaction between a supplier and a buyer on the assumption that various banks, export agents and a shipping company, etc., take part.

2. System for Supporting Trade Transactions

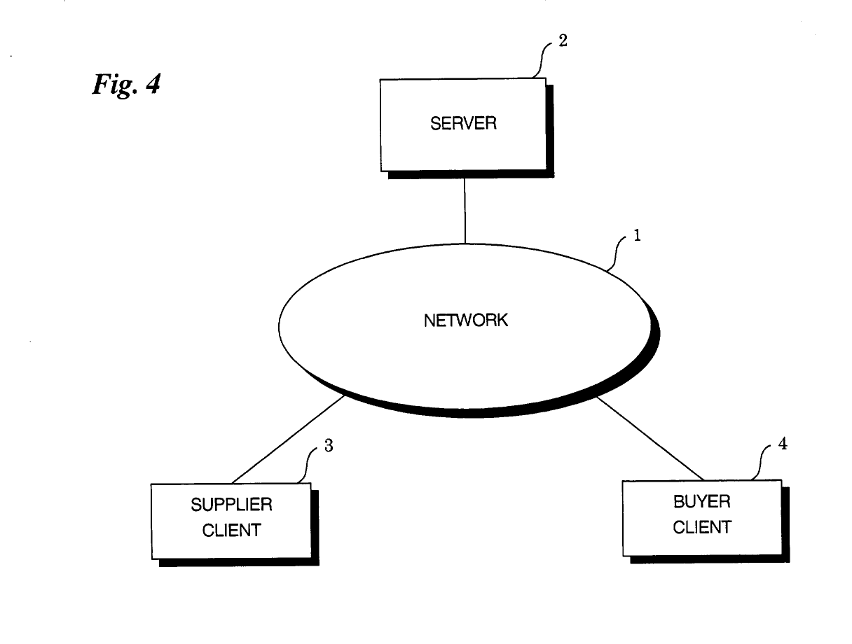

FIG. 4 is a block diagram illustrating the overall configuration of a system for supporting trade transactions.

The system for supporting trade transactions comprises a server computer (referred to as a “server” below) 2 capable of being connected to a network 1, a supplier client 3 and a buyer client 4. The server 2 is placed under the control of the supplier (exporter), the buyer (importer) or a third party. The supplier client 3 is placed under the control of the supplier and the buyer client 4 under the control of the buyer.

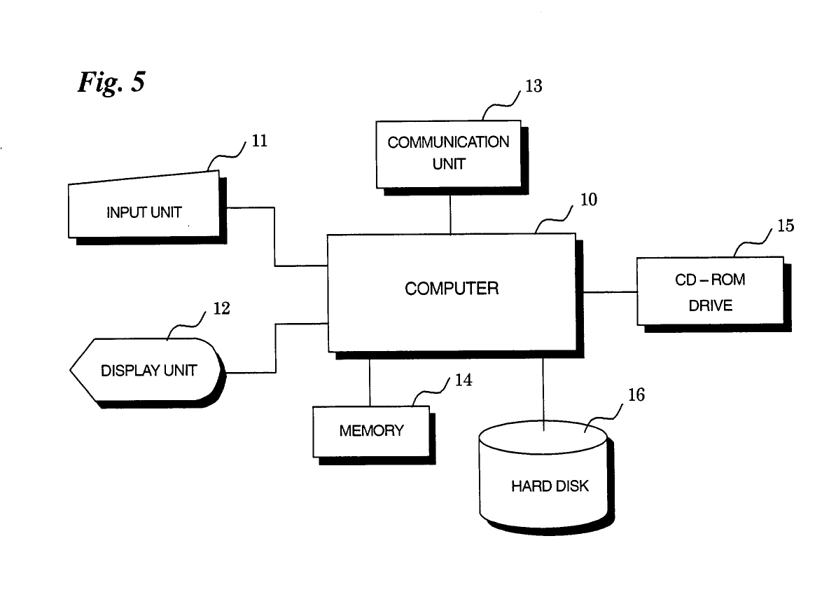

FIG. 5 is a block diagram illustrating the hardware implementation of the server 2.

The server 2 includes a computer 10. Connected to the computer 10 are an input unit (keyboard, mouse, etc.) for accepting inputs; a display unit 12 for displaying the results of processing and various images; a communication unit 13 for connection to the network 1; a memory 14 that provides a program area that stores a program executed by the computer 10, a work area for various arithmetic operations and a buffer area; a CD-ROM drive 15 for reading programs and data recorded on a CD-ROM; and a hard disk (HD) 16 on which an operating system and the like have been stored. Of course, a floppy-disk device and a magnetic-tape device also can be connected to the computer 10.

The supplier client 3 and buyer client 4 basically have hardware identical with that of the server 2.

As will be described later, the supplier client 3 and buyer client 4 can access the server 2 through the network 1 and the results of executing various programs by the server 2 can be displayed on the display screens of display units possessed by the supplier client 3 and buyer client 4. The supplier client 3, buyer client 4 and server 2 construct a client/server system. The server 2 may be furnished with the functions of a Web server. Results of processing by the server 2 can be displayed on the display units of the supplier client 3 and buyer client 4 using a browser (a program for perusing a Web page). In any case, data that has been entered using an input unit at the supplier client 3 or buyer client 4 can be reflected in the results of processing performed by the server 2.

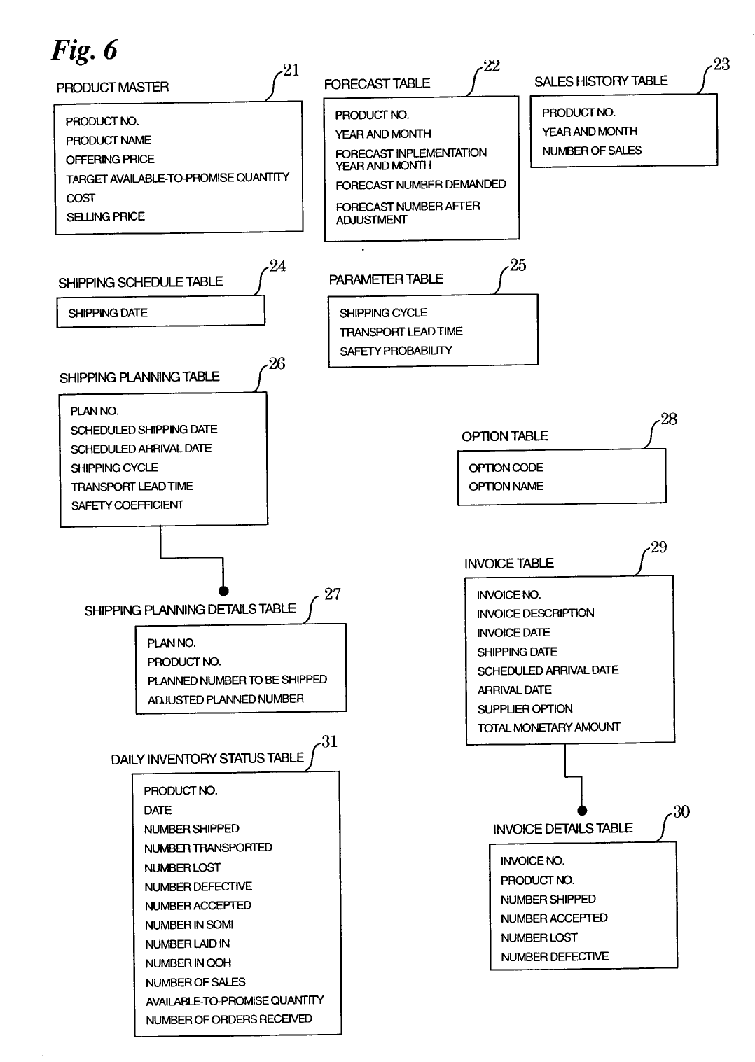

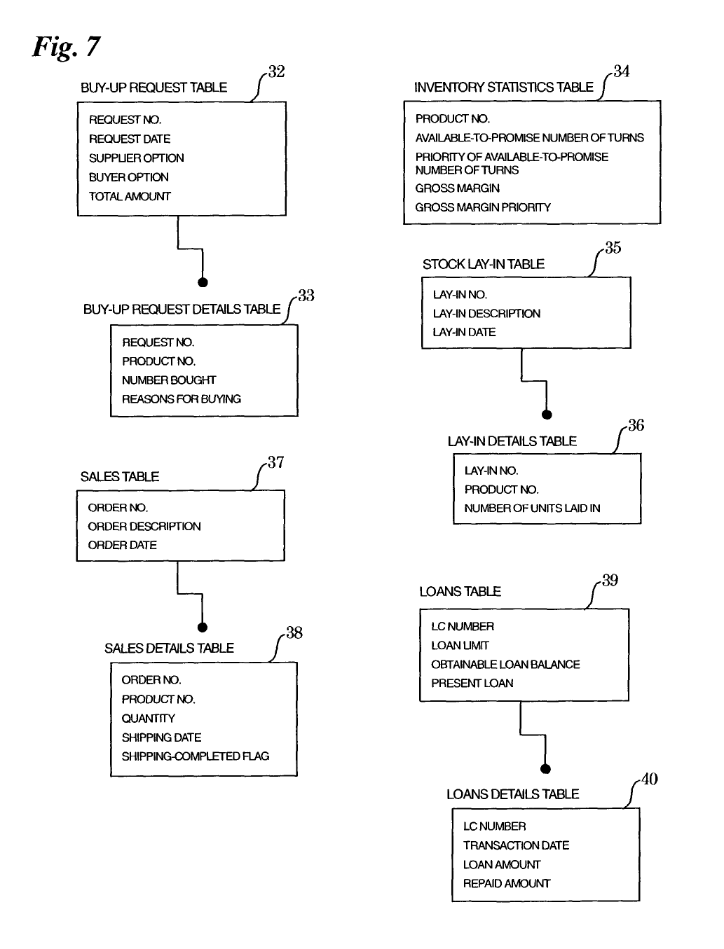

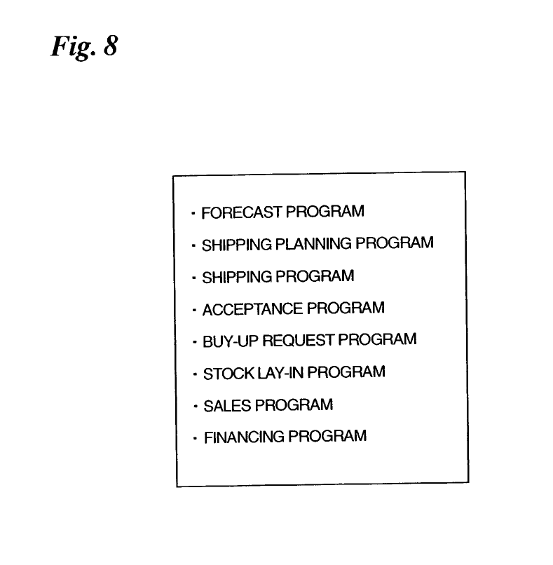

Various tables and programs relating to trade transactions have been stored on the hard disk 16 of the server 2. FIGS. 6 and 7 illustrate trade-related tables stored on the hard disk 16 as well as the items included in each of the tables. FIG. 8 shows trade-related programs stored on the hard disk 16 of the server 2.

The following tables have been prepared on the hard disk 16 of the server 2 as tables relating to trade transactions: a product master 21; a forecast table 22; a sales history table 23; a shipping schedule table 24; a parameter table 25; a shipping planning table 26 and shipping planning details table 27; an option table 28; an invoice table 29 and invoice details table 30; a daily inventory status table 31; a buy-up request table 32 and buy-up request details table 33; an inventory statistics table 34; a stock lay-in table 35 and stock lay-in details table 36; a sales table 37 and sales details table 38; and a loans table 39 and loans details table 40. The trade-related programs that are prepared are as follows: a forecast program, shipping planning program, acceptance program, buy-up request program, stock lay-in program, sales program and financing program. These tables and programs are used to operate the transactions supporting system.

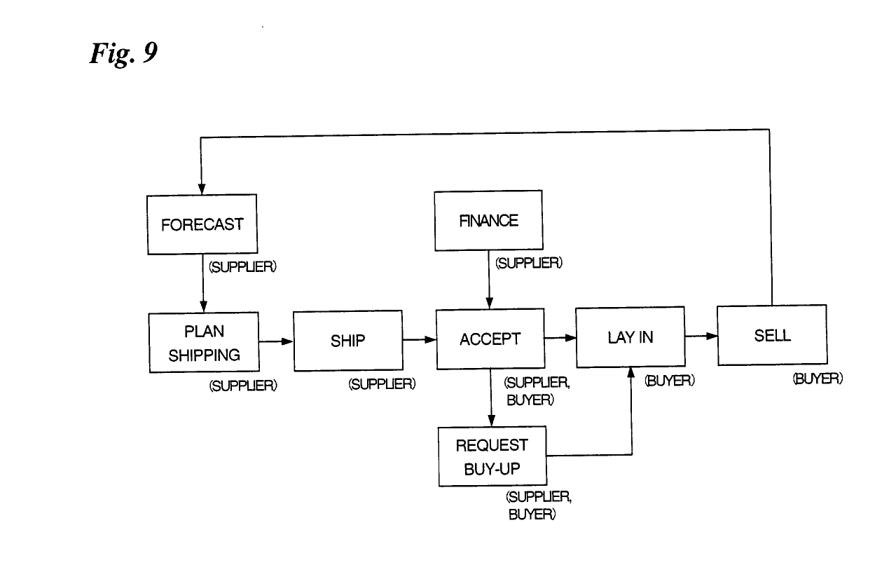

FIG. 9 is a block diagram showing the corresponding relationship of processing operations in accordance with the above-mentioned eight types of programs stored on the hard disk 16.

In accordance with this system for supporting trade transactions, the operation of the overall system is implemented by cooperation among the eight programs. The details of processing in accordance with each program will be described later. Described first in simple terms is an overview of processing based upon the eight types of programs.

Forecast processing: This is processing in which the quantity of sales, etc., of sales of a product from a buyer to a customer is forecast with regard to a product that the buyer has purchased from a supplier. (This processing is executed by the forecast program.)

Shipping planning processing: This is processing for planning products and the quantities thereof to be shipped from the supplier to the buyer. The purpose of this processing is to grasp as inventory all quantities of products that are SOMI, QOH and presently in transit by ship and to hold constant the available-to-promise quantity (product inventory that has neither been sold nor promised for sale). (This processing is executed in accordance with the shipping planning program.)

Shipping processing: This is processing for recording a track record of shipping actually performed by the supplier. (This processing is executed in accordance with the shipping planning program.)

Acceptance processing: This is processing basically for recording a track record of actual acceptance of a product in SOMI. This processing is for determining whether the monetary amount of stock in SOMI (the total monetary amount of a product received as SOMI) has exceeded a reimbursement amount stipulated by a standby letter of credit. (This processing is executed by the acceptance program.)

Buy-up request processing: This processing is executed if the monetary amount of stock in SOMI (the total monetary amount of a product received as SOMI) has exceeded a reimbursement amount stipulated by the standby letter of credit. This processing is for having the buyer buy up the product in an amount commensurate with the amount of excess. (This processing is executed by the buy-up request program.)

Stock lay-in processing: This is processing for recording stock lay-in performance by the buyer for laying in a product from SOMI to QOH. (This processing is executed in accordance with the stock lay-in program.)

Sales processing: This is processing for recording a track record of sales of a product by the buyer. (This processing is executed in accordance with the sales program.)

Financing processing: This is processing for recording a track record of loans and payments by the supplier. (This processing is executed by the financing program.)

The eight types of processing mentioned above are interrelated. For example, forecast processing is executed based upon the results of sales processing and shipping planning processing is executed based upon the results of forecast processing. Of the eight types of processing, the forecast processing, shipping planning processing, shipping processing and financing processing can be referred to as processing for the supplier. The stock lay-in processing and sales processing can be referred to as processing for the buyer. The acceptance processing can be referred to as processing for the supplier and buyer. Whether the acceptance processing is processing for the supplier or buyer depends upon whether the business of managing the SOMI is being carried out by the supplier or buyer. The buy-up request processing is performed at the initiative of the buyer who lays in stock. However, using the supplier client 3, the supplier also can monitor results of processing based upon buy-up request processing. A conference with the buyer is held in conformity with the results of buy-up request processing. Of course, even if processing is that for the buyer, the results thereof are used in processing for the supplier, and even if processing is that for the supplier, the results thereof are used in processing for the buyer. In either case, the system for supporting trade transactions operates as a whole owing to cooperation among the eight types of processing.

3. Details of Various Processing

(1) Forecast Processing

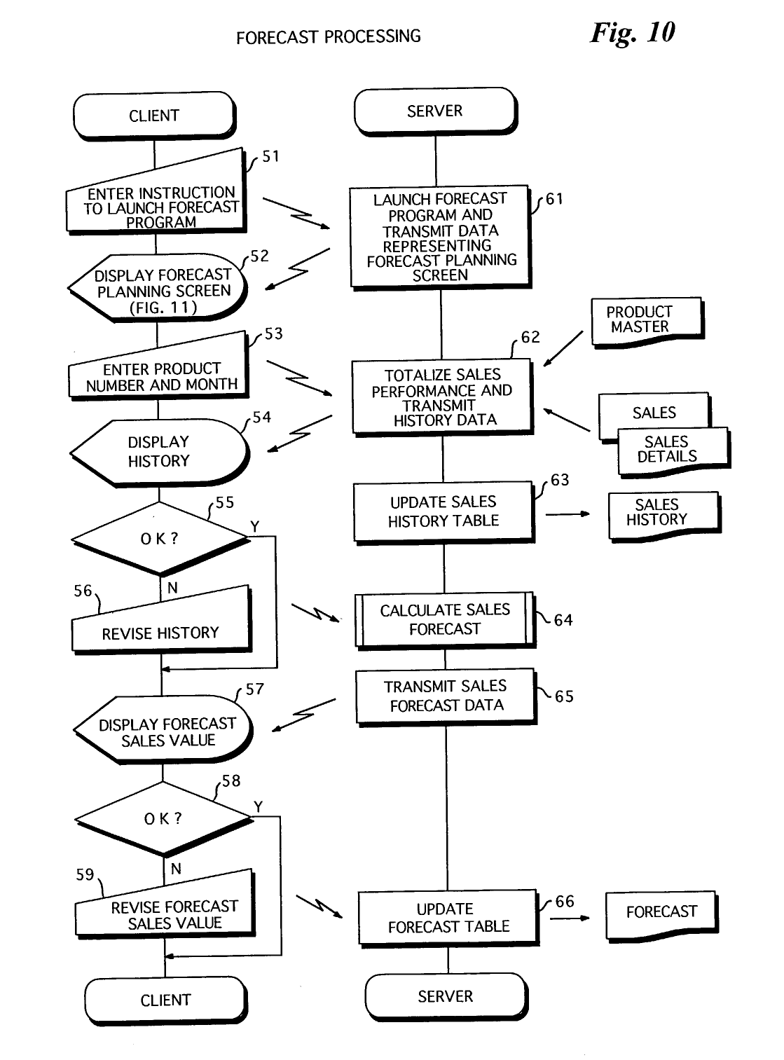

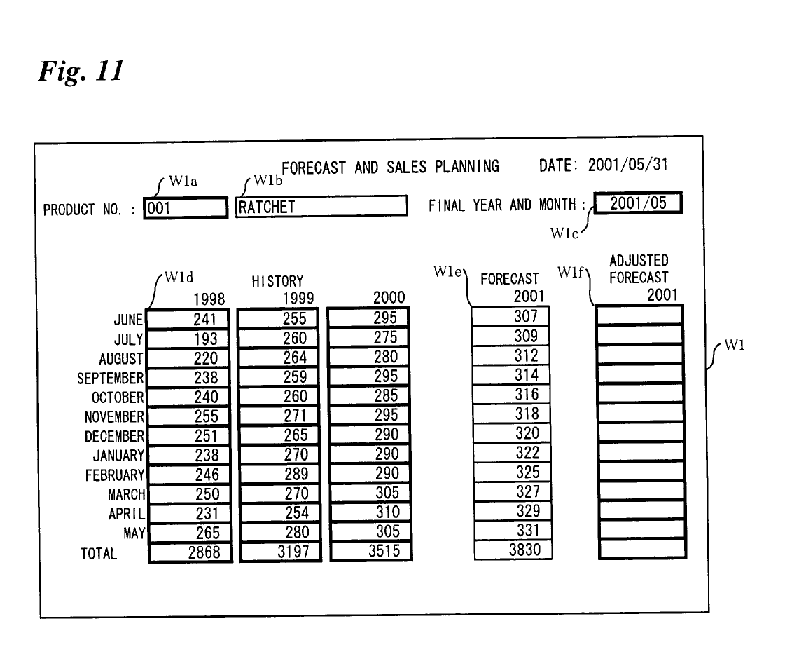

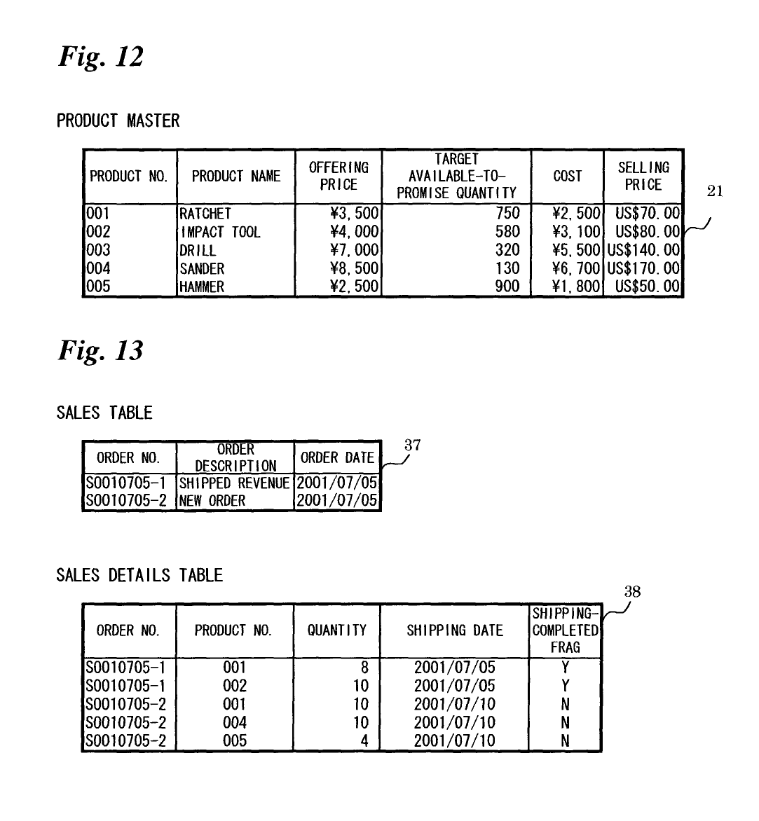

FIG. 10 is a flowchart illustrating processing executed by the server 2 and by a client (mainly the supplier client 3) in forecast processing, as well as the flow of data transmission and reception. Forecast processing is based upon the forecast program that has been stored on the hard disk 16. The supplier client 3 is used to input data employed in forecast processing and to display the results of processing (an input/output screen) based upon the forecast program in the server 2. FIG. 11 illustrates an example of a display presented on the display screen of the display unit of supplier client 3 based upon processing in accordance with the forecast program. FIGS. 12 to 15 illustrate examples of the various tables (product master 21, sales table 37, sales details table 38, sales history table 23 and forecast table 22) used in forecast processing.

The forecast processing based upon the forecast program is for forecasting (by the supplier) quantity of buyer sales of a product supplied from the supplier to the buyer, as mentioned above. The buyer sells the product, which has been supplied from the supplier, to customers (consumers). In accordance with the quantity of sales of a product by the buyer, the supplier forecasts the type and quantity of a product to be shipped to SOMI.

The various tables (product master 21, sales table 37, sales details table 38, sales history table 23 and forecast table 22) used in forecast processing will be described first.

Product Master (FIG. 12)

The product master 21 is provided with the following items: product number, product name, offering price, target available-to-promise quantity, cost and selling price.

“PRODUCT NO.” is an identification number that identifies each product supplied from the supplier to the buyer. “PRODUCT NAME” is the name (popular name) of each product corresponding to a product number.

“OFFERING PRICE” is the price per one unit of the product (i.e., the unit price) when the supplier supplies (offers) the product to the buyer.

“TARGET AVAILABLE-TO-PROMISE QUANTITY” is the total number (a target value) of units of an available-to-promise product to be placed in inventory in SOMI, QOH and transport (by ship).

“COST” is the cost incurred by the supplier, such as the cost for producing the product. The value obtained by subtracting the cost from the above-mentioned price is the gross margin of the supplier per one unit of the product.

“SELLING PRICE” is the price per one unit of the product when the buyer sells the product to customers (consumers). The value obtained by subtracting the above-mentioned offering price from the selling price is the gross margin of the buyer per one unit of the product.

Sales Table 37 and Sales Details Table 38 (FIG. 13)

The sales table 37 is provided with the following items: order number, order description and order date.

“ORDER NO.” is a number assigned whenever the buyer receives an order for a product from a customer. For example, “S0010705” signifies receipt of an order on Jul. 5, 2001. If several orders are received on the same day, suffixes (−1, −2, . . . ) are assigned.

“ORDER DESCRIPTION” provides a description of the content of a received order. For example, if a product was shipped immediately after receipt of the order, “SHIPPED REVENUE” is entered here. If an order has been received but has been allocated or is in the process of being placed in stock, “NEW ORDER” is entered.

“ORDER DATE” represents the date (day, month and year) on which the buyer received the order.

The sales details table 38 is provided with the following items: order number, product number, quantity, shipping date and shipping-completed flag. The sales details table 38 and sales table 37 are linked to each other by the order number, and the sales details table 38 and product master 21 (FIG. 12) are linked to each other by the product number.

“QUANTITY” represents the number of units of a product that the buyer has sold to customers. The shipping date or scheduled shipping date of the sold product is stored under “SHIPPING DATE”.

A flag representing whether the product was shipped from QOH is stored under “SHIPPING-COMPLETED FLAG”. A flag “Y” is stored if a product was shipped from QOH by the buyer, and a flag “N” is stored if the product was not shipped from QOH.

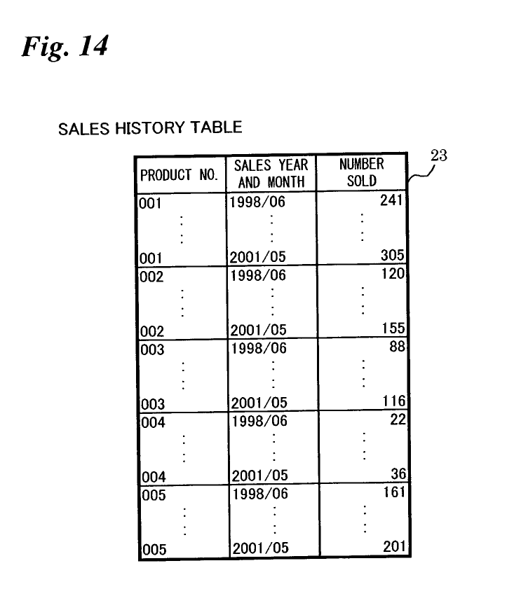

Sales History Table 23 (FIG. 14)

The sales history table 23 is provided with the following items: product number, sales year and month, and number sold.

“SALES YEAR AND MONTH” is the year and month in which a product identified by the product number was sold. The number of units of the product sold (the total number sold in one month) in that year and month is stored under “NUMBER SOLD”. In this embodiment, 36 month's worth of sales performance has been stored for every product.

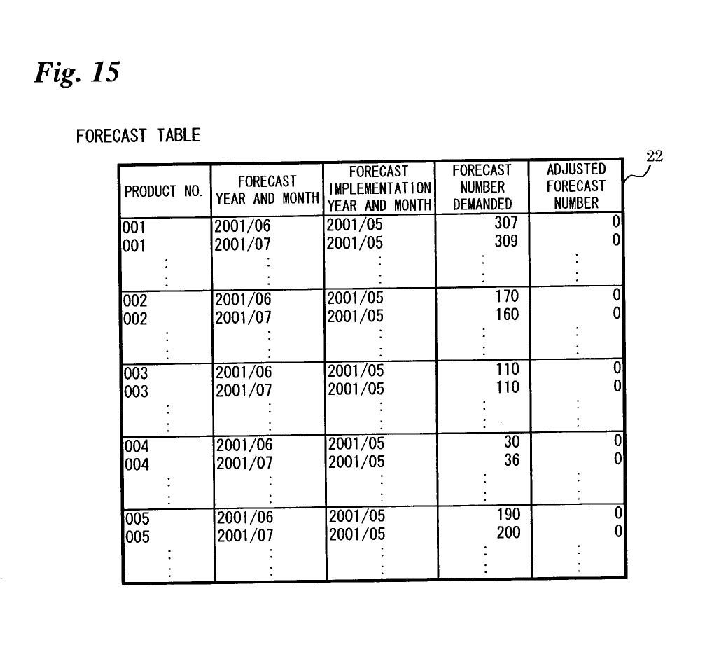

Forecast Table 22 (FIG. 15)

The forecast table 22 is provided with the following items: product number, forecast year and month, forecast implementation year and month, forecast number demanded and adjusted forecast number.

“FORECAST YEAR AND MONTH” is the year and month on which the number of units of a product to be sold by the buyer is forecast by forecast processing (the details of which will be described later). For example, if the number of units of a product to be sold in June, 2001 (a time in the future) has been forecast, then “2001/06” is stored as the forecast year and month.

“FORECAST IMPLEMENTATION YEAR AND MONTH” is the year and month on which the forecast processing was executed.

“FORECAST NUMBER DEMANDED” is the number of units of a product forecast to be sold by the buyer. This number is calculated by forecast processing.

As will be described later, the forecast number demanded calculated by forecast processing can be revised (adjusted) by the operator of the supplier client 3. A forecast number demanded that has been revised is stored under “ADJUSTED FORECAST NUMBER”. If a revision (adjustment) is not made, the value stored here is “0”.

The flow of processing executed by the server 2 and supplier client 3 in forecast processing will now be described with reference to FIG. 10.

If the operator of the supplier client 3 enters a forecast-program launch instruction from an input unit (step 51), data representing the launch instruction is transmitted from the supplier client 3 to the server 2 via the network 1. [Processing for data transmission is executed by a communication program (browser, etc.) with which the supplier client 3 is equipped.] At the server 2 the forecast program is read into the computer 10 from the hard disk 16 and processing in accordance with the forecast program starts.

Data (html data, asp data etc.) representing a forecast planning screen is transmitted from the server 2 to the supplier client 3 (step 61). A forecast planning screen W1 (FIG. 11) is displayed on the display screen of the display unit of supplier client 3 (step 52).

The forecast planning screen W1 displays the following fields: a product number input field W1a, a product name display field W1b, a final year and month input field W1c, a history display input field W1d, a forecast value display field W1e and an adjusted forecast value input field W1f. [In the initial state (step 52), no characters or numerals are displayed in any of the above-mentioned input and display fields.] [In order to facilitate an understanding of the screen, fields (input fields) in which the operator can make an input are indicated by bold borders.] The operator of the supplier client 3 enters, in the product number input field W1a, the product number of a product the number of units of which to be sold by the buyer in the future is to be forecast, and enters, in the final year and month input field W1c, the final year and month to be displayed in the display (the display of the history display input field W1d) of past sales performance (“HISTORY”: three year's worth of month-by-month sales performance) (step 53). The entered data (data representing the product number and data representing the final month) is transmitted from the supplier client 3 to the server 2.

The product name that corresponds to the product number entered with reference to the product master 21 (FIG. 12) is read out by the server 2. Data representing the product name (a ratchet in this example) corresponding to the entered product number is transmitted from the server 2 to the supplier client 3, and the product name (ratchet) is displayed in the product name display field W1b.

The server 2 totals the buyer's sales performance regarding the product (ratchet) (referred to as a “designated product” below) specified by the product number entered at the supplier client 3 (step 62). Data representing the fact that the designated product was ordered or sold by the buyer has been stored in the sales table 37 and sales details table 38 (FIG. 13), and the numbers of units of each product sold per month have been collected together in the sales history table 23 (FIG. 14). The numbers of units of designated products sold per month are totaled by referring to the sales table 37 and sales details table 38, and the results are written in the sales history table 23 (step 63). (Of course, it is not necessarily required to execute totalization processing if totalization has been completed. Accordingly, totalization processing usually is executed only in the final month.

Data representing the month-by-month sales performance of the designated product over the past 36 months counting backwards from the year and month entered in the final year and month input field W1c is transmitted from the server 2 to the supplier client 3. The month-by-month sales performance (numbers of units sold) regarding the designated product (ratchet) is displayed in the history display input field W1d on the display screen of supplier client 3 (step 54; display history).

The number of units sold displayed in the history display input field W1d can be revised by the operator of the supplier client 3. One reason for this is that it may be necessary to revise the number of units sold in a month and year in which sales were overly depressed by insufficient stock, to a number of units that presumably would have been sold if stock had been sufficient. If the operator of the supplier client 3 decides that a revision is necessary, the operator enters the value (the revised value) in the history display input field W1d using the input unit (“NO” at step 55; step 56). The revised value that has been entered is displayed in the history display input field W1d instead of the actual number of units sold. If it is decided that no revision is necessary, no revision of the history is carried out (“YES” at step 55). If the number of units sold has been revised, data representing the revised value is transmitted from the supplier client 3 to the server 2. The revised value is used in a sales forecast calculation described next. (The revised value is employed as a value used in the sales forecast calculation; the sales history table 23 itself is not changed.)

The sales forecast calculation is performed (step 64). This calculation is performed for every designated product in the following manner, by way of example:

An equation representing a regression line is found based upon the month-by-month number of units of every product sold stored in the sales history table 23 (FIG. 14) and the above-mentioned revision of the revision has been made. (There are instances where the recursion to the straight line is such that the sales status increases monotonously, decreases monotonously or is constant. If such is not the case, a regression quadratic curve or a regression exponential curve is used.) The equation representing the regression line is found as follows, by way of example:

The first step is to find the average value of numbers of units of the designated product sold over a total of three months, namely the month of interest, the month preceding it and the month following it. For example, assume that the numbers of units of “RATCHET” sold in June, July and August of 1998 were 241, 193 and 220, respectively. The average value is 218, so that 218 is adopted as the average value of sales of the designated product “RATCHET” in July, 1998. The average value is found in the same way from the numbers of units sold in July, August and September of 1998. This average value found is made the average value for August, 1998. A regression-line equation (the general form of which is y=a+bx, where a and b are constants) is found by the method of least squares based upon 34 average values obtained is similar fashion from 36 months of sales performance. The number (forecast number of sales) of units (to be forecast) of the designated product sold in a (future) year and month is calculated (step 64). The calculated monthly forecast number of sales is recorded in the “FORECAST NUMBER DEMANDED” field of forecast table 22 (FIG. 15) (step 66). The year and month in which forecast processing was executed is recorded in the “FORECAST IMPLEMENTATION YEAR AND MONTH” field.

Data (sales forecast data) representing one year of month-by-month forecast number of sales regarding the designated product (ratchet) calculated by the sales forecast calculation is transmitted from the server 2 to the supplier client 3 (step 65). The month-by-month forecast number of sales of the designated product is displayed in the forecast value display field W1e on the display screen of supplier client 3 (step 57).

The operator of the supplier client 3 can revise the forecast value of sales calculated by the server 2 and displayed in the forecast value display field W1e. If it is judged that a revision is necessary, the operator of the supplier client 3 enters the value (the revised value) in the adjusted forecast value input field W1f using the input unit (“NO” at step 58; step 59). If it is judged that a revision is not necessary, then it is not required to make the revision of the forecast value of sales (“NO” at step 58). The data representing the revised value entered in the adjusted forecast value input field W1f is transmitted from the supplier client 3 to the server 2. The server records the monthly forecast number of sales in the “FORECAST NUMBER DEMANDED” field of forecast table 22 (FIG. 15), records the year and month in which forecast processing was executed in the “FORECAST IMPLEMENTATION YEAR AND MONTH” field and records the data representing the entered revised value under the “FORECAST NUMBER AFTER ADJUSTMENT” field (step 66).

(2) Shipping Planning Processing

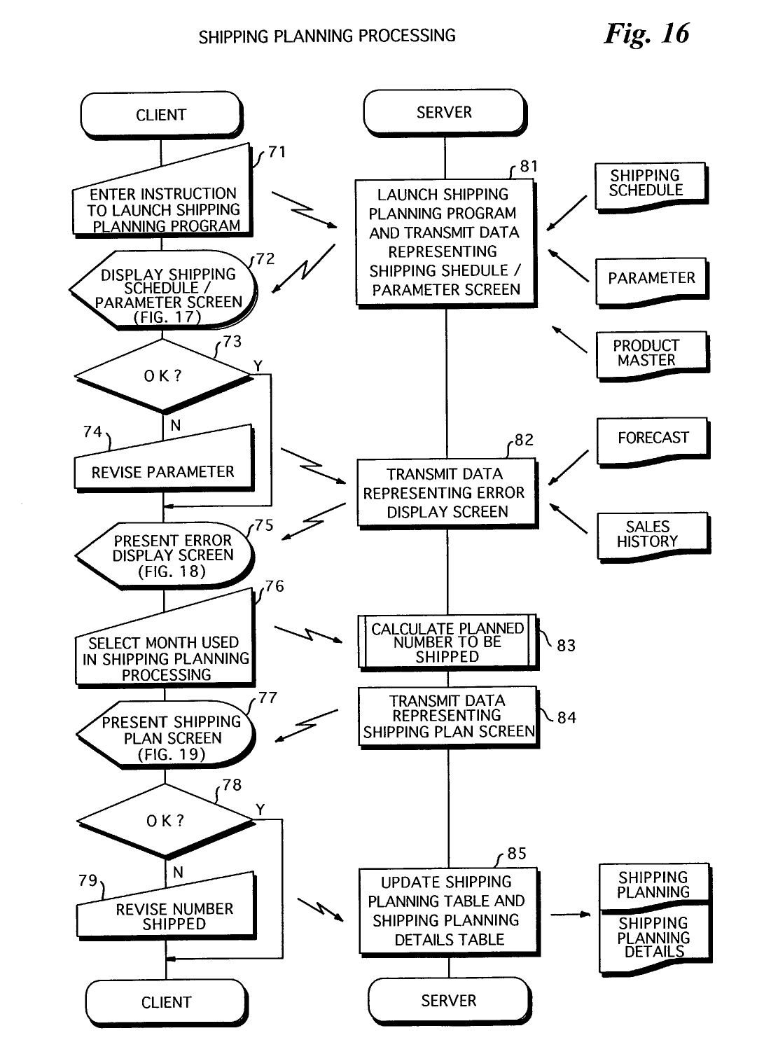

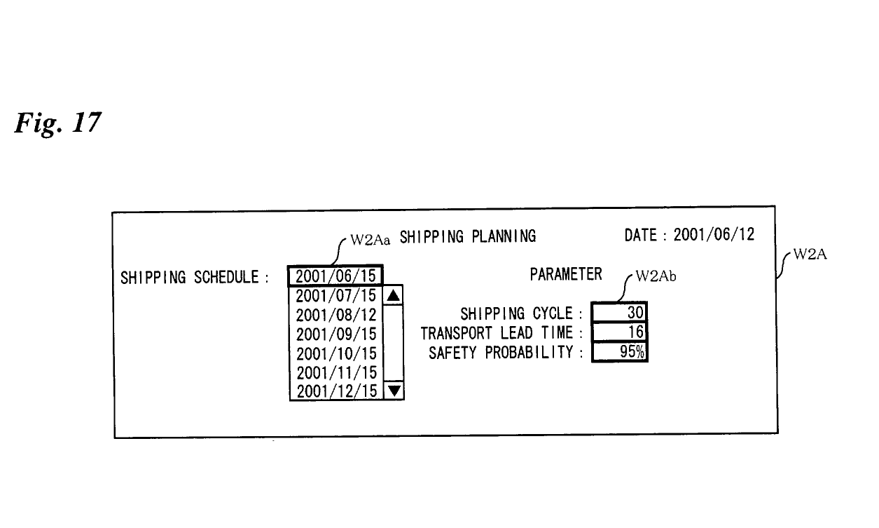

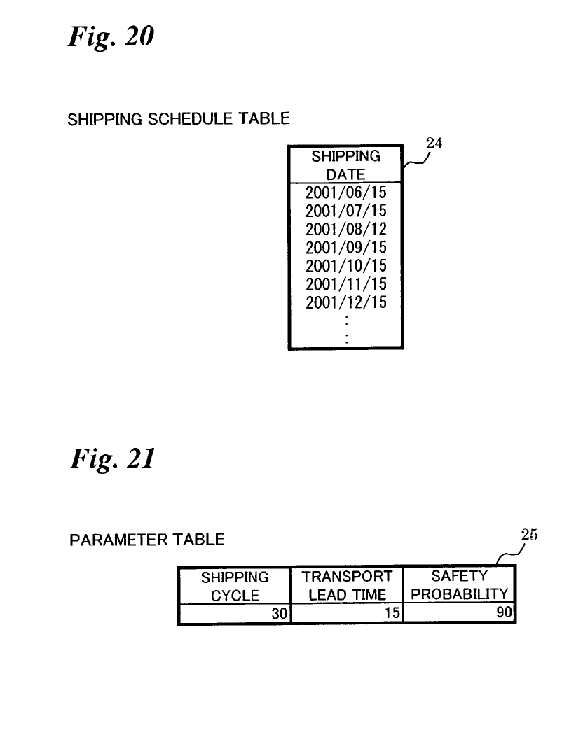

FIG. 16 is a flowchart illustrating processing executed by the server 2 and by a client (mainly the supplier client 3) in shipping planning processing, as well as the flow of data transmission and reception. This shipping planning processing is based upon a shipping planning program that has been stored on the hard disk 16 of the server 2. The supplier client 3 is used to enter data employed in shipping planning processing and to display the results of processing (an input/output screen) based upon the shipping planning program of the server 2. FIGS. 17 to 19 illustrate examples of displays presented on the display screen of the display unit of supplier client 3 based upon processing in accordance with shipping planning program. FIGS. 20 to 22 illustrate examples of various tables (shipping schedule table 24, parameter table 25, shipping planning table 26 and shipping planning details table 27) used in shipping planning processing.

As mentioned above, shipping planning processing based upon the shipping planning program is processing in which the supplier plans a product and the quantity thereof to be shipped to a buyer in order that the total number (available-to-promise quantity) of units of a product in SOMI, QOH and in transit will be held constant. First, the shipping schedule table 24, parameter table 25, shipping planning table 26 and shipping planning details table 27 will be described.

Shipping Schedule Table 24 (FIG. 20)

Shipping date (scheduled shipping date) is recorded in the shipping schedule table 24. The shipping date is the scheduled departure date of the ship, etc.

Parameter Table 25 (FIG. 21)

The parameter table 25 is provided with the following items: shipping cycle, transport lead time and safety probability.

“SHIPPING CYCLE” is the number of days to the next scheduled shipping date. If a scheduled shipping date that follows a scheduled shipping date regarding shipping for which shipping planning processing is executed has not been recorded in the above-mentioned shipping schedule table 24, then the number of days that has been recorded under “SHIPPING CYCLE” is utilized provisionally as the number of days to the next scheduled shipping date, as will be described later. However, since actual shipping is carried out at a substantially fixed cycle, there is not much difference between a provisional number of days and the actual number of days. Accordingly, a calculation formula for inventory management based upon the so-called “periodic ordering method” is applied also in the calculation of planned number of units of a product to be shipped, described below.

“TRANSPORT LEAD TIME” is the number of days from shipping to SOMI arrival.

“SAFETY PROBABILITY” (the details of which will be described below) is used when a supplier plans the quantity of a product to be shipped to a buyer in processing for calculating number of units planned to be shipped, described later.

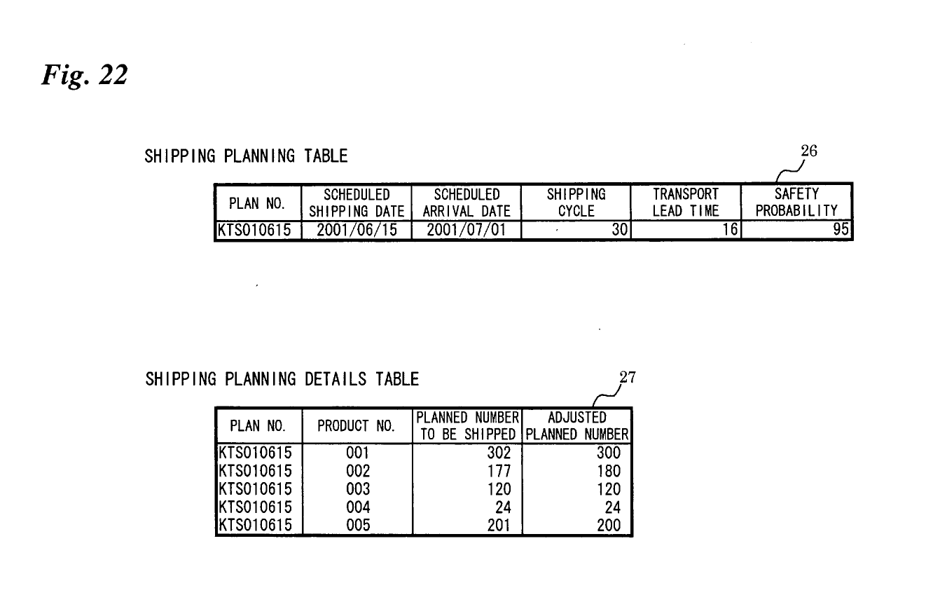

Shipping Planning Table 26 and Shipping Planning Details Table 27 (FIG. 22)

The shipping planning table 26 is provided with the following items: plan number, scheduled shipping date, scheduled arrival date, shipping cycle, transport lead time and safety probability.

“PLAN NO.” is a number assigned for every shipping plan. Scheduled shipping date and scheduled arrival date regarding shipping planning specified by the plan number are stored.

“SHIPPING CYCLE”, “TRANSPORT LEAD TIME” and “SAFETY PROBABILITY” fields basically store numerical values the same as those stored in the above-described parameter table 25. As will be set forth later, the shipping cycle, transport lead time and safety probability can be changed by the operator of the supplier client 3. If a change has been made, the changed values are stored in the shipping cycle, transport lead time and safety probability fields, respectively, of shipping planning table 26.

The shipping planning details table 27 is provided with the following items: plan number, product number, planned number to be shipped and adjusted planned number. The shipping planning details table 27 and above-described shipping planning table 26 are linked by plan number, and the shipping planning details table 27 and product master 21 (FIG. 12) are linked by product number.

“PLANNED NUMBER TO BE SHIPPED” is the number of units of a product, which is to be shipped from the supplier to the buyer, calculated by processing (described later) for calculating the planned number to be shipped. As will be described later, the planned number to be shipped calculated by processing for calculating the planned number to be shipped can be revised by the operator of the supplier client 3. A numerical value revised by the supplier client 3 is stored in the “ADJUSTED PLANNED NUMBER” field.

The flow of processing by the server 2 and supplier client 3 in shipping planning processing will now be described with reference to FIG. 16.

If the operator of the supplier client 3 enters an instruction to launch the shipping planning program from the input unit (step 71), data representing the launch instruction is transmitted from the supplier client 3 to the server 2 via the network 1. Processing in accordance with the shipping planning program starts at the server 2.

First, shipping schedule/parameter screen data is transmitted from the server 2 to the supplier client 3 (step 81). A shipping schedule/parameter screen W2A (FIG. 17) is displayed on the display screen of the supplier client 3 (step 72).

The shipping schedule/parameter screen W2A includes a shipping schedule selection display field W2Aa and a parameter display input field W2Ab. Any of the dates (shipping dates) that have been stored in the above-described shipping schedule table 24 (FIG. 20) is selected and displayed in the shipping schedule selection display field W2Aa. Shipping planning is carried out with regard to the shipping date selected. The transport lead time and safety probability that have been stored in the parameter table 25 (FIG. 21) are displayed as default values in the parameter display input field W2Ab. With regard to the shipping cycle, the number of days from the selected shipping date to the next shipping date is displayed. If the next shipping date has not been decided, the shipping cycle that has been stored in the parameter table 25 is used.

The numerical values (shipping cycle, transport lead time and safety probability) being displayed in the parameter display input field W2Ab can be revised by the operator of the supplier client 3. If a correction is to be made, the operator of the supplier client 3 enters the revised values using the input unit (“NO” at step 73; step 74). If a revision has been made, data representing the revised value is transmitted from the supplier client 3 to the server 2 and is stored in the shipping planning table 26 (FIG. 22). If a correction is not made, the content of the parameter display input field W2Ab displayed in accordance with the data transmitted from the server 2 is stored in the shipping planning table 26.

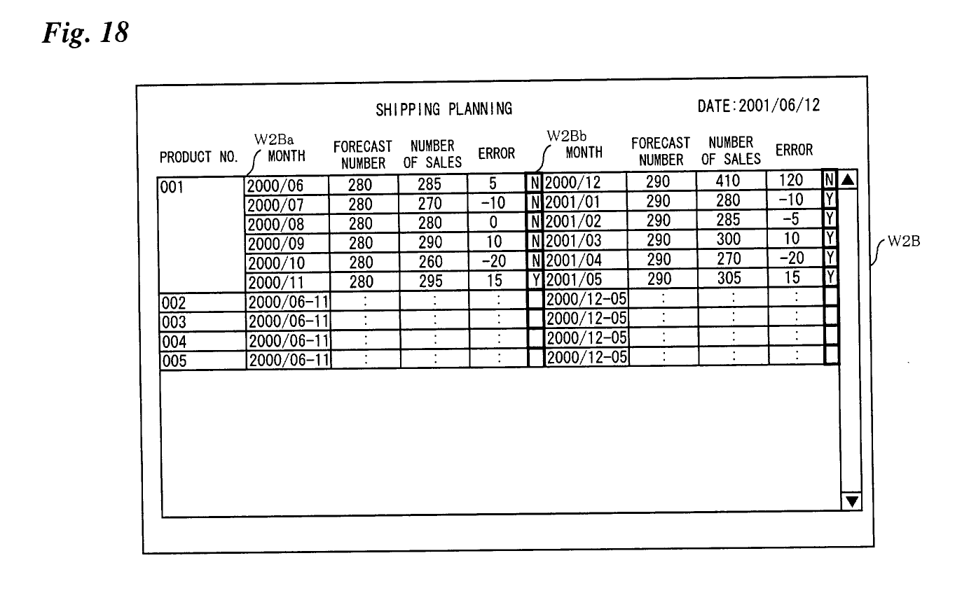

Next (e.g., if the operator of the supplier client 3 presses a predetermined function key on the input unit), error display screen data is transmitted from the server 2 to the supplier client 3 (step 82). An error display screen W2B (FIG. 18) is displayed on the display screen of the supplier client 3 (step 75).

The error display screen W2B includes a field W2Ba for displaying, with regard to designated products forecast by the above-described forecast processing, the forecast number of sales, the number of sales actually made by the buyer and the difference (error) between the two. The display field W2Ba also displays the product number and year and month (forecast year and month/sales year and month) together with the forecast number of sales, number of sales and error.

Six month's worth of the forecast number, number of sales and error (these shall be referred to collectively as “performance”) can be displayed, or these can be displayed on a month-by-month basis. If a product number is selected using the input unit (e.g., as by clicking on the number using a mouse), the six-month performance display changes over to the month-by-month performance display. If the product number is clicked once again, the month-by-month performance display changes over to the six-month performance display. In FIG. 18, the month-by-month performance is being displayed with regard to the product whose product number is “001”.

In calculation of a safe inventory quantity, described later, performance over the latest six months (six months starting from the month preceding the actual year and month on which shipping planning processing is being executed, where the actual year and month is based upon the machine time of the server 2) is used as a default. With regard to performance used in calculation of the safe inventory quantity, there are cases where the performance for a year and month in which the value was abnormal is excluded from the calculation of planned number of units of a product to be shipped. The year and month used in the calculation of safe inventory quantity is selected using a selection field W2Bb. The character “Y” is stored in a selection field W2Bb that corresponds to a year and month used in calculation of safe inventory quantity, and “N” is stored in a selection field W2Bb that does not correspond to a year and month used in calculation of safe inventory quantity (step 76).

If the operator of the supplier client 3 presses a predetermined function key on the input unit, data representing a year and month (selected year and month, namely a year and month for which the aforementioned “Y” has been stored) used in shipping forecast processing is transmitted from the supplier client 3 to the server 2. The server 2 calculates the planned number of units to be shipped (step 83).

In the processing (step 83) for calculating the planned number of units to be shipped, the server 2 executes processing for calculating the number of units to be shipped (the planned number of units to be shipped) in regard to every product to be shipped, as well as the safe inventory quantity that is based upon a statistical error.

By way of example, the planned number of units to be shipped is found by adding the target available-to-promise quantity to the forecast value of sales calculated by the above-described forecast processing, and then subtracting from this value a predicted available-to-promise quantity effective on the shipping date.

Thus, as described above, forecast number of sales by a buyer product by product is calculated on a monthly basis in sales forecast processing. In processing for calculating planned number of units to be shipped, first processing is executed to revise the forecast value of sales, which has been calculated on a monthly basis, to a forecast value of sales over a shipping cycle period with the shipping date (scheduled shipping date) (the date selected in the shipping schedule/parameter screen W2A described above) serving as a reference.

For example, assume that the shipping date (scheduled shipping date) is Jun. 15, 2001 and that the shipping cycle is 30 days. If the forecast value of sales for June, 2001 and that for July, 2001 calculated by the sales forecast processing are “307” and “309”, respectively (see FIG. 11), then the forecast value of sales from Jun. 15, 2001 to Jul. 14, 2001 will be calculated to be 303 as follows: 307×(16/30)+309×(14/31)≈303. Here “15/30” signifies 15 days of 30 days (the number of days in June) and “14/31” signifies 14 days of 31 days (the number of days in July). Thus, the forecast value of sales over the period of the shipping cycle is calculated using the scheduled shipping date as a reference.

The target available-to-promise quantity uses a numerical value that has been written in the product master 21 (FIG. 12). In the case of the product whose product number is “001”, the target available-to-promise quantity is “750”. The value “750” is added to the forecast value “380” of sales in the shipping cycle for which the above-mentioned scheduled shipping date is the reference. The value “1130” is calculated.

Next, the available-to-promise quantity (predicted available-to-promise quantity) on the shipping date (scheduled shipping date) is calculated.

The available-to-promise quantity is stored in a daily inventory status table (described later). However, since the shipping date (scheduled shipping date) is a date in the future, the available-to-promise quantity on the shipping date has not yet been stored in the daily inventory status table. For this reason, an estimated value of available-to-promise quantity on the shipping date is calculated. This value is the predicted available-to-promise quantity.

For example, assume that the date on which shipping planning processing is executed is Jun. 12, 2001 and that the (actual) available-to-promise quantity on Jun. 12, 2001 is “787”. There is a period of three days until the shipping date of Jun. 15, 2001. Accordingly, if the forecast value of sales for June, 2001 calculated by forecast processing was, say, “307”, then, in accordance with the calculation 307×(3/30)≈31, a forecast can be made to the effect that 31 units of the product will be allocated (will be sold or promised for sale) in the period of three days. The predicted available-to-promise quantity on Jun. 15, 2001 is estimated to be 787−31=756.

By calculation, the scheduled number of units to be shipped is the forecast value of sales (303) over the period of the shipping cycle+the target available-to-promise quantity (750)−the predicted available-to-promise quantity (756)=297.

The safe inventory quantity is obtained as set follows, by way of example:

First, a standard deviation is calculated. The standard deviation is found by the following equation:

[(maximum value of error)−(minimum value of error)]×a coefficient

where the coefficient is a value predetermined by the number of samples. If the number of samples is six, for example, then the coefficient is 0.3946.

The maximum value of error in six months (e.g., November, 2000 and January, February, March, April, May, 2001) sampled in FIG. 18 is 15, the minimum value is −20 and the number of samples is six. By calculation, therefore, the standard deviation is 15−(20)×0.3946 ≈13.811.

The safe inventory quantity is calculated in accordance with the following equation:

standard deviation×safety coefficient×SQRT [(transport lead time+shipping cycle)/30]

where SQRT(x) is the square root of x.

Here the safety coefficient is a value calculated beforehand based upon safety probability. For example, the safety coefficient is 1.65 if the safety probability is 95%.

If the transport lead time is 16 days and the shipping cycle is 30 days, the following calculation is performed: standard deviation (13.811)×safety coefficient (1.65)×SQRT {[transport lead time (16)+shipping cycle (30)]/30}=28.25. Thus the safe inventory quantity is calculated to be 28. Whereas the scheduled number of units to be shipped is decided in such a manner that the available-to-promise quantity (the quantity for which an immediate response or immediately delivery is made from buyer to customer) will not fall below a fixed quantity, the safe inventory quantity indicates the minimum necessary quantity to be reserved as inventory capable of immediately delivery to SOMI and QOH. Accordingly, though the safe inventory quantity is not a value utilized directly in calculation of scheduled number of units to be shipped, it is calculated and displayed as data to be taken into consideration in deciding the “TARGET AVAILABLE-TO-PROMISE” per se in the product master (FIG. 12).

The scheduled number of units to be shipped and the safe inventory quantity of every product are calculated in the same manner. Data for a shipping plan screen that includes the scheduled number of units to be shipped and the safe inventory quantity thus calculated is transmitted from the server 2 to the supplier client 3 (step 84).

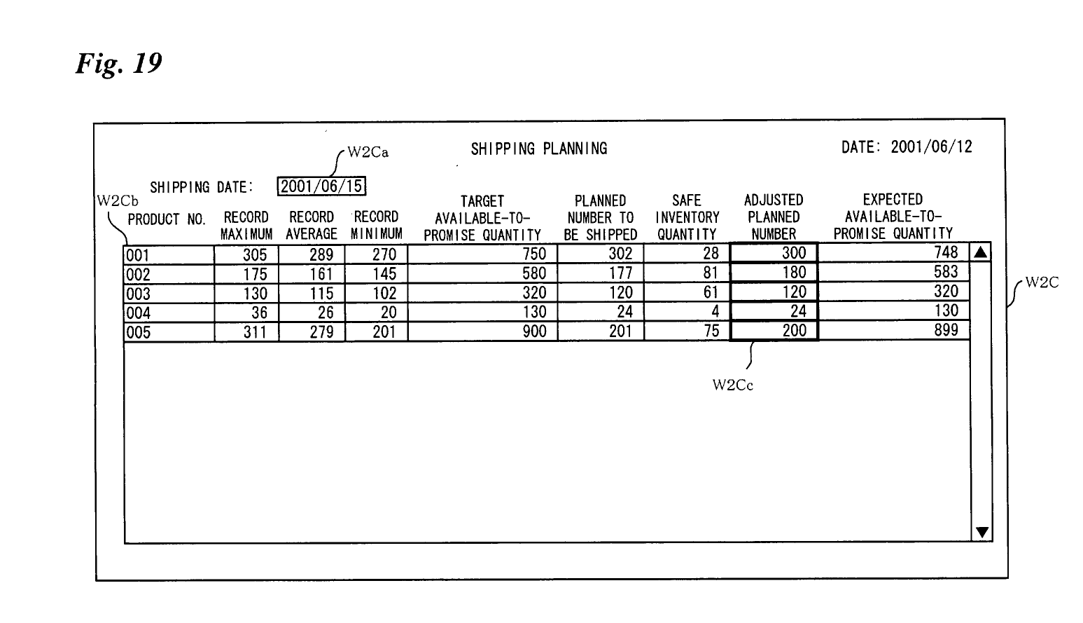

A shipping plan screen W2C (FIG. 19) includes a shipping date display field W2Ca and a shipping plan display field W2Cb. The following are displayed in the shipping plan display field W2Cb with regard to each product for which shipping planning processing has been executed: product number, record maximum number of sales (record maximum), record average number of sales (record average), record minimum number of sales (record minimum), target available-to-promise quantity, scheduled number of units to be shipped, safe inventory quantity, adjusted scheduled number, and expected available-to-promise quantity, all of which prevail on the sampled date. Only the adjusted scheduled number can be entered (revised) (this section being designated by reference characters W2Cc).

The scheduled number of units to be shipped calculated by the server 2 can be revised as the adjusted scheduled number. The reason for this is that if “297” was calculated as the scheduled number to be shipped, for example, the number to be shipped is made “300” taking into account such factors as the packing of the product in boxes. A revised scheduled number of units to be shipped is entered in the field W2Cc that displays the adjusted scheduled number (“NO” at step 78; step 79). If revision is unnecessary, the scheduled number of units to be shipped need not be revised (“YES” at step 78).

If an adjustment has been applied to the scheduled number of units to be shipped, a figure obtained by adding (or subtracting) the adjusted number to (or from) the target available-to-promise is displayed under “EXPECTED AVAILABLE-TO-PROMISE QUANTITY”. For example, if the scheduled number of units to be shipped is “297” and “300” has been entered as the adjusted scheduled number (product number “001” in FIG. 19), then “753”, which is obtained by adding 3 to the target available-to-promise quantity “750”, is displayed as the expected available-to-promise quantity. If an adjustment of the scheduled number of units to be shipped has not been made, then a number identical with the target available-to-promise quantity is displayed as the expected available-to-promise quantity (e.g., product number “003”).

A new plan number is assigned and stored in the plan number field of the shipping planning table 26 (FIG. 22). Also stored in the shipping planning table 26 are scheduled shipping date [the scheduled shipping date selected on the shipping schedule/parameter screen W2A (FIG. 17)] and scheduled arrival date (the date obtained by adding transport lead time to the scheduled shipping date). Stored in the field for scheduled number of units to be shipped in the shipping planning details table 27 (FIG. 22) are scheduled numbers to be shipped calculated so as to correspond to respective ones of the product numbers. In a case where a scheduled number of units to be shipped has been revised (by entry of a numerical value in the field W2Cc for the adjusted scheduled number) by the operator of the supplier client 3 on the shipping plan screen W2C (FIG. 19), this value is stored in the field for the adjusted scheduled number in the shipping planning details table 27 (step 85). If no revision is made, the value in the adjusted scheduled number field is the same as the scheduled number of units to be shipped.

(3) Shipping Processing

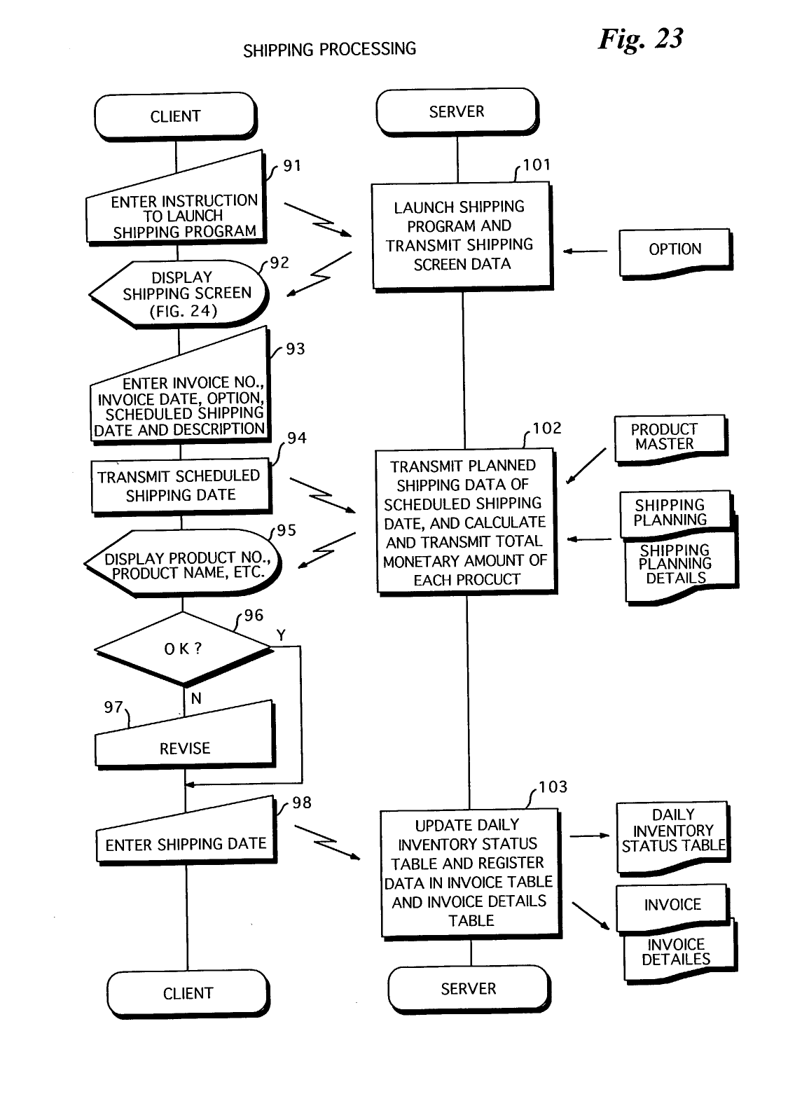

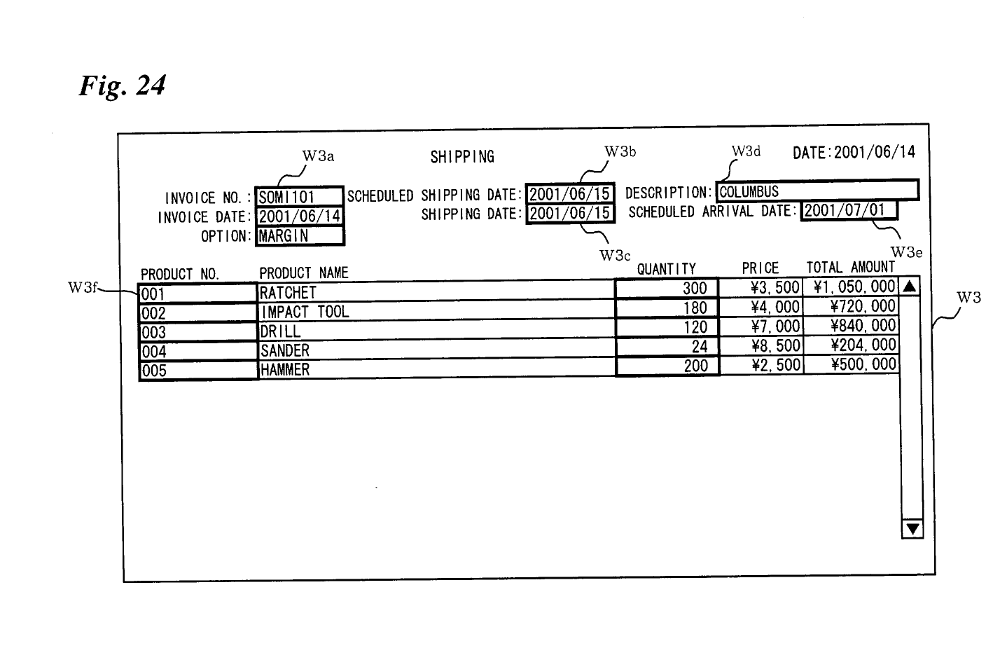

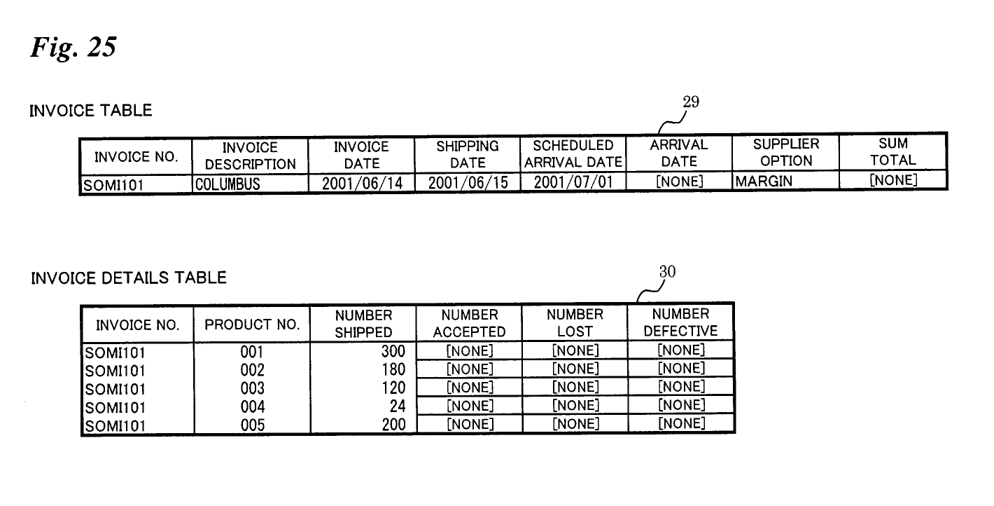

FIG. 23 is a flowchart illustrating processing executed by the server 2 and by a client (mainly the supplier client 3) in shipping processing, as well as the flow of data transmission and reception. This shipping processing is based upon a shipping program that has been stored on the hard disk 16 of the server 2. FIG. 24 illustrates an example of a display presented on the display screen of the display unit of supplier client 3 based upon processing in accordance with the shipping program. FIGS. 25 to 27 illustrate examples of various tables (invoice table 29 and invoice details table 30, option table 28 and daily inventory status table 31, respectively) used in shipping processing.

Shipping processing in accordance with the shipping program is processing for recording a track record of shipping actually carried out by the supplier, as mentioned above. First, the invoice table 29, invoice details table 30, option table 28 and daily inventory status table 31 used in shipping processing will be described.

Invoice Table 29 (FIG. 25)

The invoice table 29 is provided with the following items: invoice number, invoice description, invoice date, shipping date, scheduled arrival date, arrival date, supplier option and sum total. The data stored in the invoice table 29 is data that the operator of the supplier client 3 enters using the shipping screen, as will be described later. Since FIG. 25 represents the status of the table immediately after execution of shipping processing, “NONE” is being displayed in some fields.

“INVOICE NO.” is a number assigned to an invoice issued for every shipping event. “INVOICE DESCRIPTION” describes the invoice identified by the invoice number. For example, the name of the ship used in shipping (of the product) indicated by the invoice is entered in this field.

“INVOICE DATE” represents the date (day, month and year) on which the invoice was issued.

“SHIPPING DATE” is the date (shipping date) on which shipping (of the product) indicated by the invoice identified by the invoice number was actually carried out. “SCHEDULED ARRIVAL DATE” is the date (day, month and year) on which a shipped product is scheduled to arrive at SOMI.

“ARRIVAL DATE” is the date (day, month and year) on which the product actually arrived. The arrival date is entered by the buyer and is stored in the invoice table 29.

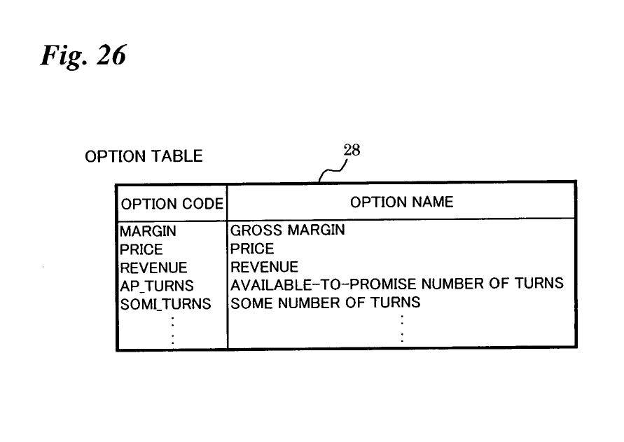

“SUPPLIER OPTION” stores which option (the details of which will be set forth below) has been stored in the option table 28 (FIG. 26) described next.

“SUM TOTAL” is the monetary total of a product actually accepted by the buyer. The sum total is entered by the buyer and is stored in the invoice table 29.

Invoice Details Table 30 (FIG. 25)

The invoice details table 30 is provided with the following items: invoice number, product number, number shipped, number accepted, number lost and number defective. The invoice details table 30 and invoice table 29 are linked by invoice number. Since FIG. 25 represents the status of the table immediately after execution of shipping processing, “NONE” is being displayed in some fields. Values will be set in these fields by subsequent acceptance processing.

Shipping content (type of product shipped and quantity of each shipped product) indicated by an invoice identified by an invoice number is stored in the invoice details table 30. The number of units of the product shipped is stored under “NUMBER SHIPPED”.

“NUMBER ACCEPTED”, “NUMBER LOST” and “NUMBER DEFECTIVE” are entered by the buyer; here the results of inspection of a product by the buyer are stored. The number of conforming articles is stored under “NUMBER ACCEPTED” and the number of defective articles is stored under “NUMBER DEFECTIVE”. In a case where the number of articles imported is less than the number shipped, the shortfall (the number of units of the product lacking) is stored under “NUMBER LOST”.

Option Table 28 (FIG. 26)

As will be described later, if the total monetary amount of a product in SOMI (the sum total of the product accepted as SOMI) exceeds a reimbursement amount stipulated by a standby letter of credit, the supplier has the buyer buy up the product in an amount commensurate with the amount of excess. Choices (options) for a case where a product (type and quantity thereof) in an amount commensurate with the amount of excess is decided by a determination made based upon a certain viewpoint have been stored in the option table 28.

Examples of the options are GROSS MARGIN, PRICE, REVENUE, AP TURNS and SOMI TURNS. The option is designated (selected) by both the supplier and buyer in acceptance processing described later. Processing for deciding the type and quantity of a product in an amount commensurate with the amount of excess executed in acceptance processing takes into consideration the option designated by both the supplier and buyer (details described later). From the standpoint of the supplier, the supplier sells a product to the buyer. Hence GROSS MARGIN signifies a demand to sell a product having a high gross margin, REVENUE signifies a demand to sell a product having high revenues, AP TURNS signifies a demand to sell a product having a high available-to-promise number of turns, and SOMI TURNS signifies a demand to sell a product having a high SOMI number of turns. From the standpoint of the buyer, the buyer purchases a product from the supplier. Hence the above-mentioned options signify the respective purchase demands (a request to purchase a product having a high gross margin, etc.).

The option desired by the supplier is stored in processing for deciding the type and quantity of a product in an amount commensurate with amount of excess executed in acceptance processing, described later.

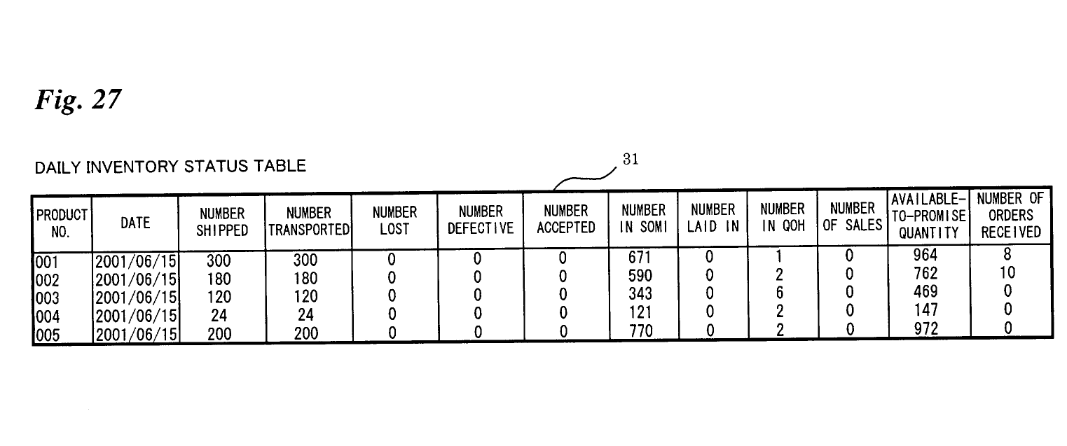

Daily Inventory Status Table 31 (FIG. 27)

The daily inventory status table 31 is provided with the following items: product number, date, number shipped, number transported, number lost, number defective, number accepted, number in SOMI, number laid in, number in QOH, number of sales, available-to-promise quantity and number of orders received. FIG. 27 illustrates only data for June 15, which is the shipping date. However, whenever a product is shipped, accepted, laid in or sold, etc., the data of that particular date is added successively to the table.

The inventory status, sales status and order status of a product for each date (year, month and day) are stored in the daily inventory status table 31.

“NUMBER SHIPPED” is the number of units of a product shipped by the supplier. “NUMBER TRANSPORTED” is the number of units of the product transported (loaded on a ship). If a product already loaded on a ship and in the process of being transported does not exist and no product is lost by the time a product shipped from the supplier (e.g., transported from the supplier's factory for the product) is loaded on the ship, then the “NUMBER SHIPPED” and the “NUMBER TRANSPORTED” on that shipping date will agree. However, if, say, a sale is made the day after shipping and new data is added on, then the “NUMBER SHIPPED” becomes “0” and the “NUMBER TRANSPORTED” is the same value as that of the previous day.

“NUMBER LOST”, “NUMBER DEFECTIVE” and “NUMBER ACCEPTED” are the same values as those in the invoice details table 30. These values are set in acceptance processing, which is described later.

“NUMBER IN SOMI” is the number of units of a product in SOMI (the product is in the ownership of the supplier). “NUMBER IN QOH” is the number of units of a product in QOH (the product is in the ownership of the buyer).

“NUMBER LAID IN” is the number of units of a product laid in stock by the buyer. If a product is laid in, SOMI decreases by the amount of lay-in and QOH increases by the amount of lay-in.

“NUMBER OF SALES” is the number of units of a product sold to customers by the buyer.

“AVAILABLE-TO-PROMISE QUANTITY” is inventory of the supplier and buyer neither sold nor promised for sale. It is a figure obtained by subtracting number of sales and number of orders (described next) from a figure obtained by adding the number transported, the number in SOMI and the number in QOH.

“NUMBER OF ORDERS RECEIVED” is the number of units of a product for which an order has been received but which has not yet been sold.

The flow of processing executed by the server 2 and supplier client 3 in shipping processing will be described with reference to FIG. 23.

If the operator of the supplier client 3 enters an instruction to launch the shipping program from the input unit (step 91), data representing the launch instruction is transmitted from the supplier client 3 to the server 2 via the network 1. The server 2 launches the shipping program and transmits data representing a shipping screen to the supplier client 3 (step 101).

A shipping screen W3 (FIG. 24) is displayed on the display screen of the supplier client 3 that has received the data representing this screen.

The shipping screen W3 includes a field W3a for entering an invoice number, invoice date and option, a scheduled shipping date input field W3b, a shipping date input field W3c, a description input field W3d, a scheduled arrival date display input field W3e, and a shipping product input display field W3f. [In the initial state (step 92), no alphabetic characters or numerals, etc., are displayed in any of the above-mentioned input and display fields.] The operator of the supplier client 3 enters an invoice number, invoice date (the date on which the invoice is issued) and any one of the above-mentioned options in the input field W3a. The operator further enters the scheduled shipping date in the input field W3b, enters the shipping date that has been finally determined in the input field W3c and enters the ship's name, etc., in the description input field W3d (step 93).

The scheduled shipping date that has been entered in the scheduled shipping date input field (plan field) W3b is transmitted from the supplier client 3 to the server 2 (step 94). The server 2 reads the shipping planning data on the scheduled shipping date to memory from the shipping planning table 26 and shipping planning details table 27 (FIG. 22). Data representing the number shipped (adjusted scheduled number) regarding a product for which shipping has been scheduled on the planning shipping date and data representing the scheduled arrival date corresponding to the scheduled shipping date is transmitted from the server 2 to the supplier client 3. Further, on the basis of the product master 21 (FIG. 12), the server 2 calculates a value (total monetary amount) obtained by multiplying the offering price of the product for which shipping is scheduled by the adjusted scheduled number. Data representing the calculated total monetary amount and the offering price is transmitted from the server 2 to the supplier client 3 (step 102). The product number, product name, scheduled number (quantity) to be shipped, offering price (price) and total amount of the product scheduled for shipping are displayed in the shipping product input display field W3f of shipping screen W3 on the display screen of the supplier client 3 (step 95). The scheduled date of arrival of the shipped product at SOMI is displayed in the scheduled arrival date display input field W3e.

It is possible to enter (revise) a product name and quantity in the shipping product input display field W3f. The type and quantity of a product to be shipped can be changed using the shipping screen (“NO” at step 96; step 97). For example, if the scheduled shipping date and actual shipping date differ depending upon the circumstances of the ship, then the shipping quantity is adjusted.

When shipping is actually carried out, the shipping date is entered in the scheduled shipping date input field W3b (step 98).

Further, when shipping is actually carried out (when a shipping date is entered in the scheduled shipping date input field W3b), the date (shipping date), number shipped and number transported are stored in the daily inventory status table 31 (FIG. 27) by the server 2. The available-to-promise quantity is changed in accordance with the number transported (step 103). Further, the date (shipping date), etc. that has been entered on the shipping screen W3 is stored in the invoice table 29 and invoice details table 30 (FIG. 25).

(4) Acceptance Processing and Buy-Up Request Processing

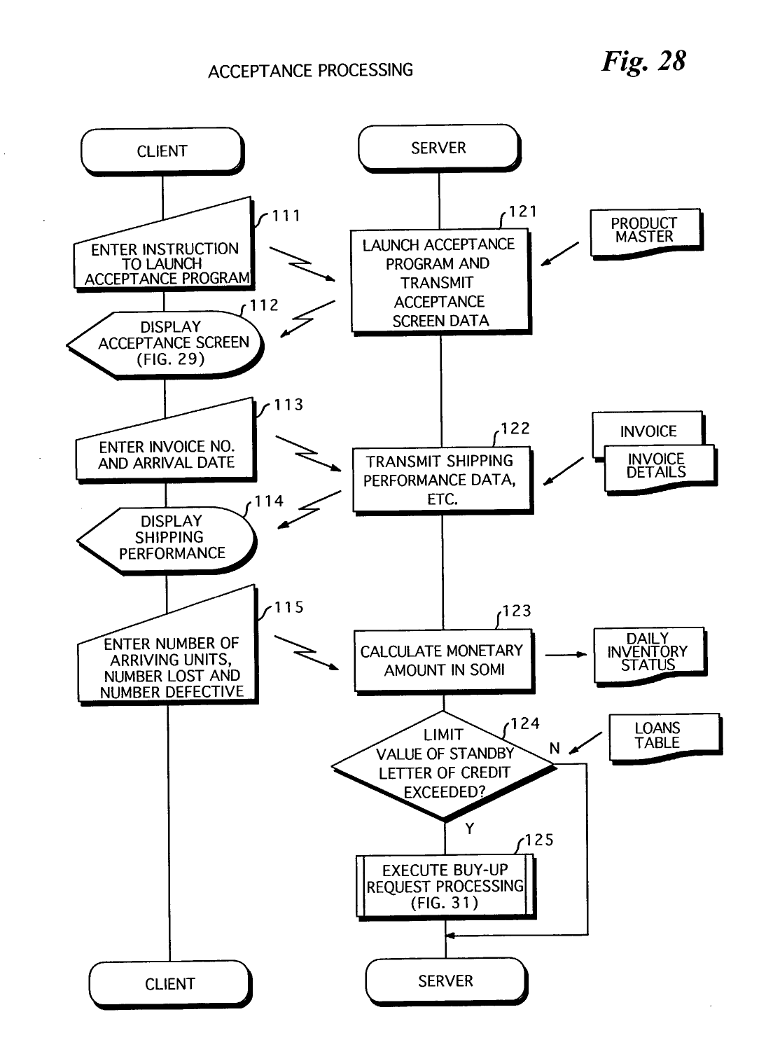

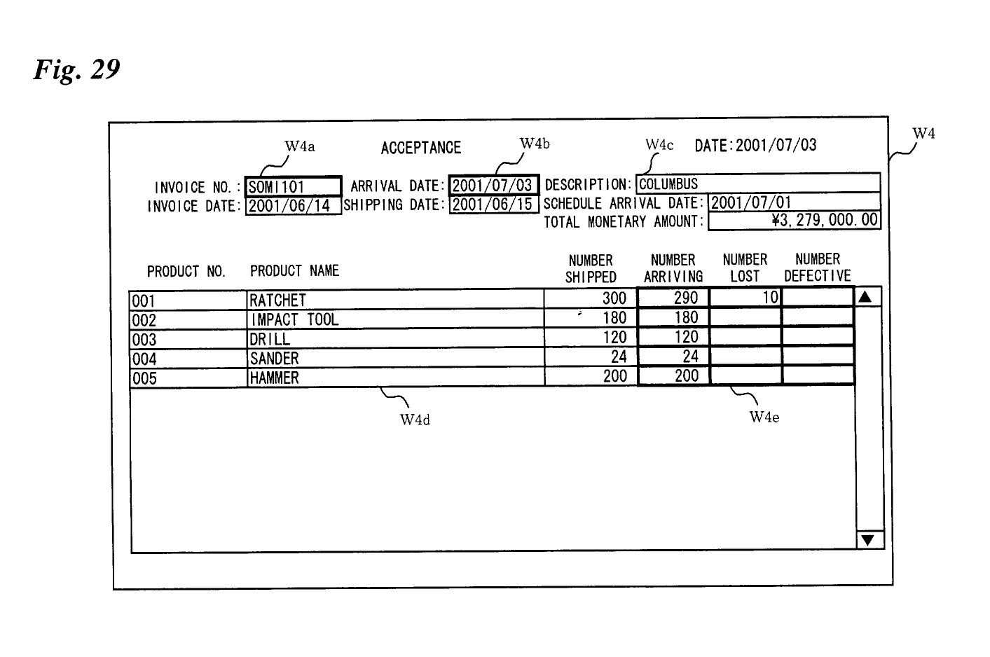

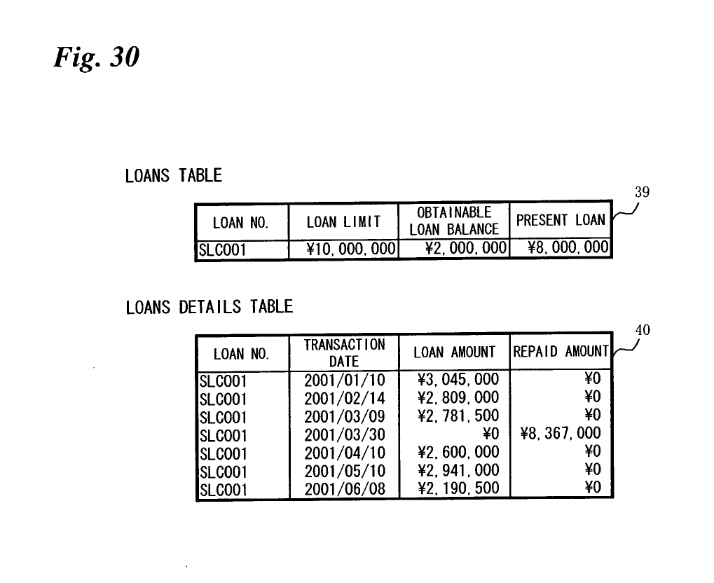

FIG. 28 is a flowchart illustrating processing executed by the server 2 and by a client (the supplier client 3 or buyer client 4, simply referred to as clients 3, 4 below) in acceptance processing, as well as the flow of data transmission and reception. The acceptance processing is based upon an acceptance program that has been stored on the hard disk 16 of the server 2. The clients 3, 4 are used to input data employed in acceptance processing and to display the results of processing (an input/output screen) based upon the acceptance program of the server 2. FIG. 29 illustrates an example of a display presented on the display screens of the display units of the clients 3, 4 based upon processing in accordance with the acceptance program. FIG. 30 shows an example of a loans table and loans details table used in acceptance processing.

Acceptance processing in accordance with the acceptance program is processing for recording a track record of actual acceptance of a product into SOMI, as mentioned above.

The loans table 39 and loans details table 40 used in acceptance processing will now be described.

Loans Table and Loans Details Table (FIG. 30)

The loans table 39 is provided with the following items: loan number, loan limit, obtainable loan balance and present loan.

“LOAN NUMBER” is a number that corresponds to a monetary loan agreement between the supplier and a bank. The loan limit in the monetary loan agreement identified by the loan number has been stored under “LOAN LIMIT”. This loan limit is written in a standby letter of credit issued by the bank in response to a request from the buyer.

“OBTAINABLE LOAN BALANCE” is the monetary amount that the supplier can borrow from the bank. It is the result of subtracting the present loan, which is stored under “PRESENT LOAN”, from the above-described loan limit.

The loans details table 40 is provided with the following items: loan number, transaction date, loan amount and repaid amount. The loans details table 40 and loans table 39 are linked by the loan number.

“TRANSACTION DATE” is the date (year, month and day) on which the supplier borrowed the sum from the bank or the date (year, month and day) on which the buyer repaid the sum to the bank. The monetary amount is stored in “LOAN AMOUNT” or “REPAID AMOUNT”.

The flow of processing executed by the server 2 and supplier client 3 in acceptance processing will be described with reference to FIG. 28.

If the operators of the clients 3, 4 enter a forecast-program launch instruction from an input unit (step 111), an acceptance program is launched by the server 2. Data representing an acceptance screen is transmitted from the server 2 to the clients 3, 4 (step 121). An acceptance screen W4 (FIG. 29 is displayed on the display screens of the clients 3, 4 (step 112).

The following fields are displayed on the acceptance screen W4: an invoice number/date input display field W4a; a product arrival date/shipping date input display field W4b; a field W4c for displaying an invoice description, scheduled arrival date and total monetary amount of the arriving product; a field W4d for displaying product numbers and the like; and a field W4e for displaying and entering number of arriving units, number of lost units and number of units defective. (In the initial state, no characters or numerals are displayed in any of the above-mentioned input and display fields.) The operators of the clients 3, 4 use their respective input units to enter an invoice number in the invoice number/date input display field W4a and date of arrival of the product in SOMI in the product arrival date/shipping date input display field W4b (step 113). The entered invoice number and product arrival date are displayed on the display screens.

The invoice number is transmitted from the clients 3, 4 to the server 2. The server 2 searches the invoice table 29 and invoice details table 30 (FIG. 25) based upon the invoice number received. Data (shipping performance) that has been stored in the invoice table 29 and invoice details table 30 in association with the invoice number received is transmitted to the clients 3, 4 (step 122). Invoice date, product shipping date, invoice description, scheduled arrival date, product number and number of units of the product shipped are displayed on the display screens of the clients 3, 4. The product name corresponding to the product number also is displayed on the display screens by making reference to the product master 21 (step 114). Further, the actual arrival date entered by the clients 3, 4 is stored in the arrival date field of invoice table 29 at the server 2.

The result of product inspection by the buyer can be stored in the field W4e for displaying and entering number of arriving units, number of lost units and number of units defective. Number of arriving units, number of lost units and number of defective units are entered and displayed for each product that arrives in SOMI (step 115). Data representing the entered number of arriving units, number of lost units and number of defective units is transmitted from the buyer client 4 to the server 2 and is stored invoice details table 30 (FIG. 25) and daily inventory status table 31 (FIG. 27).

On the basis of the number in SOMI (includes the product that arrived but does not include lost and defective units) regarding each product and offering price in the product master 21, the server 2 calculates the total monetary amount in SOMI (the sum total of the products in overall SOMI) (step 123). The calculated monetary amount in SOMI is displayed in the field W4c for displaying the total monetary amount in SOMI on the acceptance screen W4.

The server 2 further determines whether the total monetary amount in SOMI exceeds the loan limit (the loan limit stipulated in the standby letter of credit) that has been stored in the loans table 39 (FIG. 30) (step 124). If the total monetary amount in SOMI is less than the loan limit, acceptance processing is exited (“NO” at step 124). If the total monetary amount in SOMI exceeds the loan limit (“YES” at step 124), then control proceeds to buy-up request processing (step 125). If the supplier client 3 has executed acceptance processing, then the supplier hands over subsequent buy-up request processing to the buyer client 4. As described earlier, buy-up request processing (step 125) is processing for having the buyer buy up a product (for selecting the product to be bought up and deciding the quantity of the product) in an amount commensurate with excess if the amount in SOMI (the monetary sum total of the product that has been accepted as SOMI) exceeds a reimbursement amount specified in the standby letter of credit.

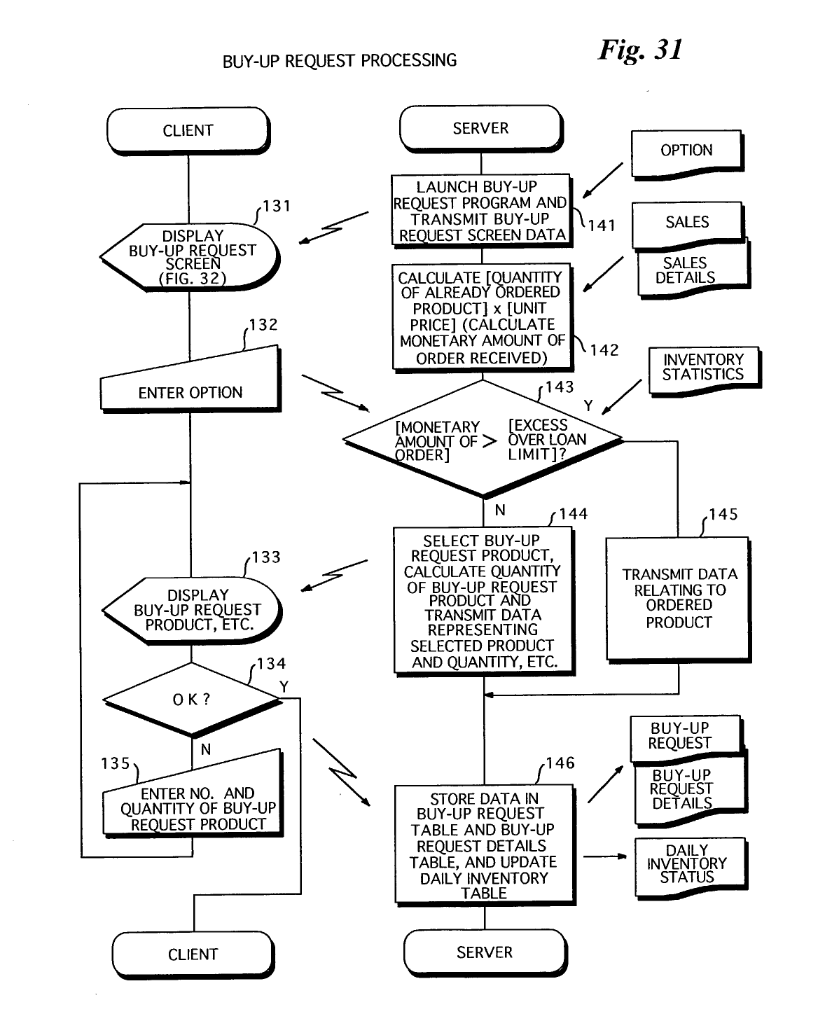

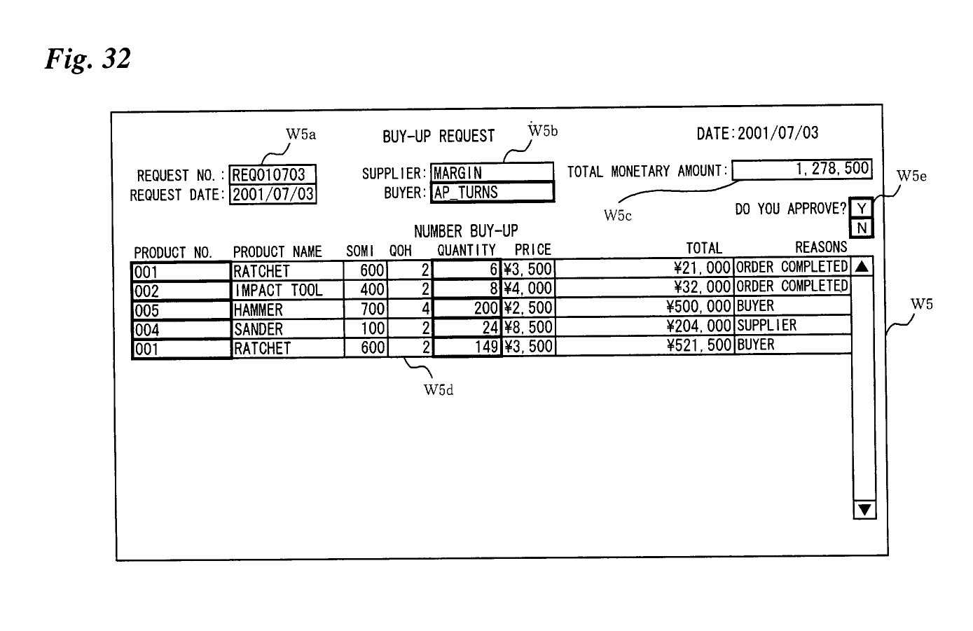

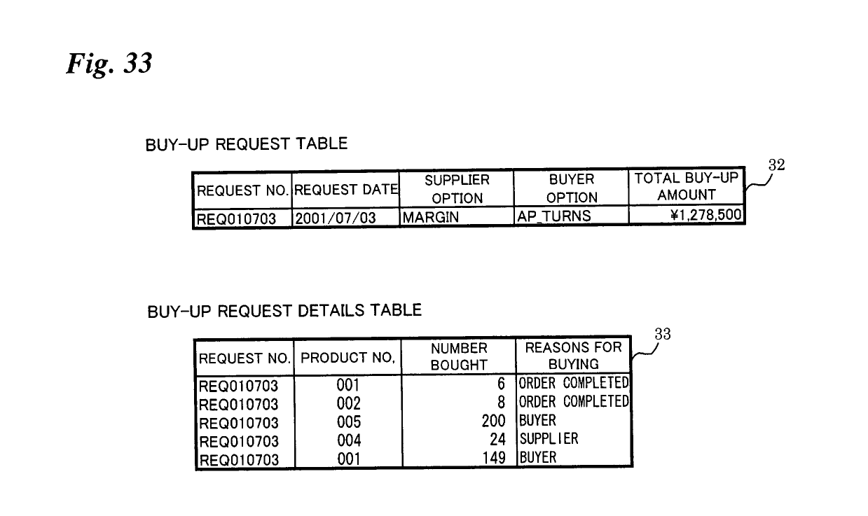

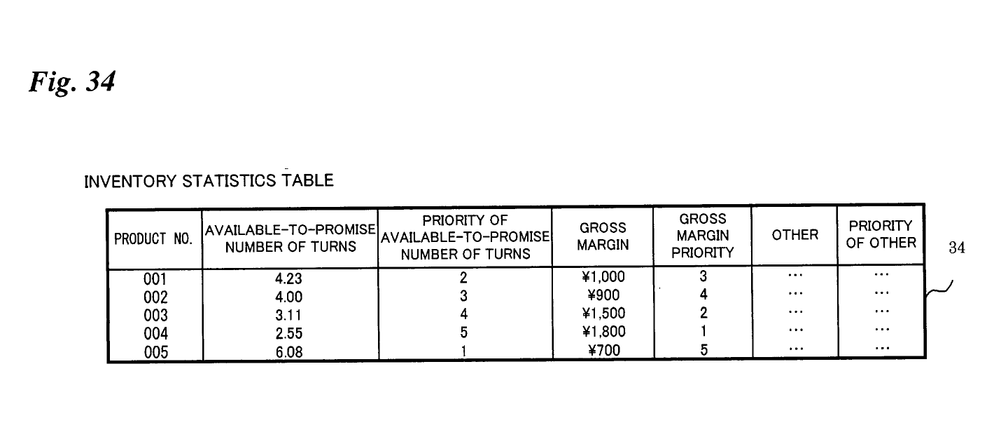

In processing for selecting the product and deciding the quantity of the selected product in buy-up request processing, the product is selected and the quantity decided in a manner that takes into consideration the intent of the supplier and buyer, as will be described later. FIG. 31 is a flowchart illustrating processing executed by the server 2 and by the buyer client 4 in buy-up request processing, as well as the flow of data transmission and reception. This buy-up request processing is based upon a buy-up request program that has been stored on the hard disk 16 of the server 2. FIG. 32 illustrates an example of a display presented on the display screen of the display unit of buyer client 4 based upon processing in accordance with the buy-up request program. FIGS. 33 and 34 illustrate examples of various tables (the buy-up request table 32 and buy-up request details table 33, and the inventory statistics table 34, respectively) used in buy-up request processing.

Buy-up Request Table and Buy-up Request Details Table (FIG. 33)

The buy-up request table 32 is provided with the following items: request number, request date, supplier option, buyer option and total amount.

“REQUEST NO.” is a number assigned whenever buy-up request processing is executed. The date (year, month and day) on which buy-up request processing was executed is stored under “REQUEST DATE”.

As mentioned earlier, “SUPPLIER OPTION” is an option selected by the supplier [namely a choice for a case where a product (type and quantity thereof) in an amount commensurate with amount of excess is decided by a determination made based upon a certain viewpoint]. “BUYER OPTION” is an option selected by the buyer. An option that has been stored in the invoice table 29 (FIG. 29) is stored under “SUPPLIER OPTION”. An option that has been selected by the buyer in buy-up request processing (described below) is stored under “BUYER OPTION”.

“BUY-UP AMOUNT” is the monetary amount of a product bought up by the buyer and is decided by buy-up request processing, described below.

The buy-up request details table 33 is provided with the following items: request number, product number, number bought up and buy-up reason. The buy-up request details table 33 and the buy-up request table 32 are linked by the request number.

“NUMBER BOUGHT” is the number of units of a product bought up by the buyer and decided by buy-up request processing, described later. “BUY-UP REASON” indicates whether the decision regarding the number bought up was made based upon the intent of the supplier (“SUPPLIER”) or the intent of the buyer (“BUYER”) or because the product is one for which an order has already been received (“ORDER RECEIVED”) at the time of execution of buy-up request processing.

Inventory Statistics Table 34 (FIG. 34)

The inventory statistics table 34 is provided with the following items: product number, available-to-promise number of turns, priority of available-to-promise number of turns, gross margin, gross margin priority, other and priority of other.

Number of turns (available-to-promise number of turns) and gross margin have been stored in the inventory statistics table 34 for each product in SOMI, and the priority of the product in SOMI has been stored in the inventory statistics table 34. As will be described later, processing for deciding a product in buy-up request processing makes reference to data that has been stored in the inventory statistics table 34.

The flow of processing executed by the server 2 and client in buy-up request processing will now be described with reference to FIG. 31.

If the monetary amount of SOMI is judged to exceed the loan limit in acceptance processing the buy-up request program is launched, as described earlier. Data representing a buy-up request screen is transmitted from the server 2 to the buyer client 4 (step 141). A buy-up request screen W5 is displayed on the display screen of the buyer client 4 (step 131; FIG. 32).

The buy-up request screen W5 (FIG. 32) includes a request number/request date display field W5a, an option display input field W5b, a total amount bought display field W5c and a field W5d for displaying and entering the content of a buy-up request. In the initial state (step 131), no alphabetic characters or numerals, etc., are displayed in option display input field W5b, total amount bought display field W5c and field W5d for displaying and entering the content of a buy-up request, which are fields regarding the buyer. A number assigned whenever buy-up request processing is executed and the date (based upon machine time of the server 2) on which buy-up request processing was executed are displayed in the request number/request date display field W5a.

The operator (buyer) of the buyer client 4 enters (selects) an option in the option display input field W5b pertaining to the buyer (step 132). In the entry (selection) of this option, the buyer selects any one of a plurality of options stored beforehand in the option table 28 (FIG. 26), in the same way that the supplier selects an option in shipping processing (FIGS. 23 to 27) described above. A purchase request from the viewpoint of the buyer is selected.

The quantity of a product (ordered product) ordered when buy-up request processing was executed is read out by the server 2 by referring to the sales table 37 and sales details table 38 (FIG. 13). The ordered product is a product that has not actually been sold (not actually been shipped) but is a product whose sale (shipping) has already been decided. In a case where a product is an ordered product, the unit price of this product and the number ordered are multiplied together to calculate the monetary amount of the received order (step 142).

The calculated monetary amount of the order is compared with the amount that exceeds the loan limit (the amount of excess over the loan limit is obtained by subtracting the loan limit from the monetary amount of SOMI) (step 143).

If the amount of excess over the loan limit is greater than the amount of the order (“NO” at step 143), the selection of a buy-up request product is made, as mentioned above.

The selection of a product for which buy-up is requested is carried out as follows:

First, a product for which an order has been received is selected as the buy-up request product.

Next, on the basis of the option that has been selected by the buyer, reference is had to the inventory statistics table 34 (FIG. 34) to decide the selection of the buy-up request product, as well as the quantity thereof, based upon the intent of the buyer.

By way of example, if the option selected by the buyer is “AP TURNS”, this signifies a buy-up request for a product having a high available-to-promise number of turns. Accordingly, reference is had to the inventory statistics table 34 (FIG. 34) and a product having a high available-to-promise number of turns [the product (“HAMMER”) whose product number is 005] is selected as the product for which there is a buy-up request.

Next, buy-up quantity the limit of which is the number of units in SOMI is decided with regard to the product that has been selected. An algorithm for deciding the quantity is used. An example of the algorithm is one which decides the maximum number of units of the product such that the monetary buy-up amount regarding the selected product (an amount obtained by multiplying the unit price of the selected product by the number of units decided) will not exceed a predetermined amount and such that the number of units of the selected product in SOMI will not be exceeded.

If the buy-up quantity of the selected product has been decided and the buy-up amount is less than the amount of excess over the loan limit, reference is had to the inventory statistics table 34 (FIG. 34) on the basis of the option selected by the supplier to thereby decide the selection of the buy-up request product, which is based upon the intent of the supplier, and the quantity of this product.

Basically, processing for selecting the buy-up product and deciding the quantity thereof involves alternately executing processing based upon the buyer option and processing based upon the supplier option. This processing is executed until the total of the monetary buy-up amount exceeds the amount of excess of the loan limit.

If the selection of the buy-up product and the quantity thereof are thus decided, data representing the selected product and quantity, etc., is transmitted from the server 2 to the buyer client 4 (step 144). The following are displayed in the field W5d for displaying and entering the content of buy-up request on the buy-up request screen W5 of buyer client 4: the product number of the selected product, the product name, the number of units in SOMI, the number of units is QOH, the decided quantity (number bought up), the product unit price, the buy-up amount and the reason (because the product is one whose order has been completed, because the product is one that has been selected based upon the buyer option, or because the product is one that has been selected based upon the supplier option).

The buy-up request screen W5 can also be displayed on the display screen of the supplier client 3. In a case where the buyer or supplier wishes to change the type or quantity of a buy-up request product that has been decided by the server 2, the decided type and quantity of the product can be changed from both the supplier side or buyer side (“NO” at step 134; step 135). Basically, an exchange of information between the supplier and buyer takes place on this display screen. However, supplementary means such as a telephone or facsimile machine may also be used for such contact between the supplier and buyer.

If the supplier and buyer have come to an agreement concerning the type and quantity of a product to be bought up, a “Y” on a button W5e is clicked (“YES” at step 134). In the daily inventory status table 31 (FIG. 27), the quantity decided with regard to the buy-up request product is shifted from the number of units in SOMI to the number of units in QOH by the server 2 (the quantity decided is subtracted from the number of units in SOMI and is added to the number of units in QOH (step 146). Data representing a track record of buy-up amount (request number, request date, option, total buy-up amount and number of each product bought up) is stored in the buy-up request table 32 and buy-up request details table 33 (FIG. 33).

In a case where the monetary amount of an order is greater than the amount of excess over the loan limit (“YES” at step 143), the ordered product is one whose sale has been set for a later date and therefore the risk of buying up the product is minimal as far as the buyer is concerned. Accordingly, this ordered product is construed to be a buy-up request product. Hence the ordered product is made a buy-up request product and the quantity that has been ordered is treated as the buy-up quantity (step 145).

(5) Stock Lay-in Processing

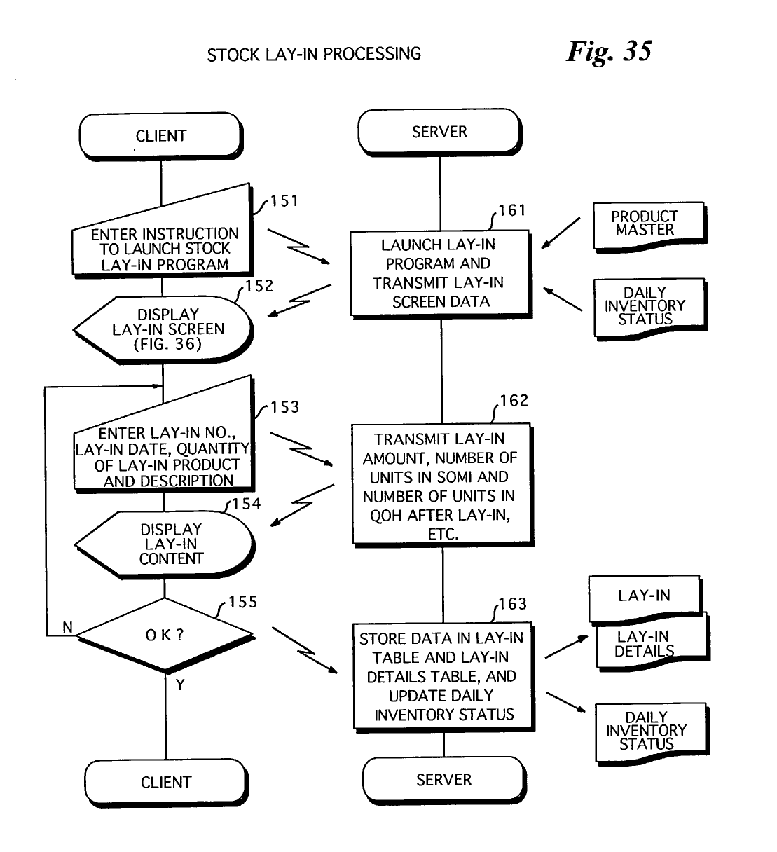

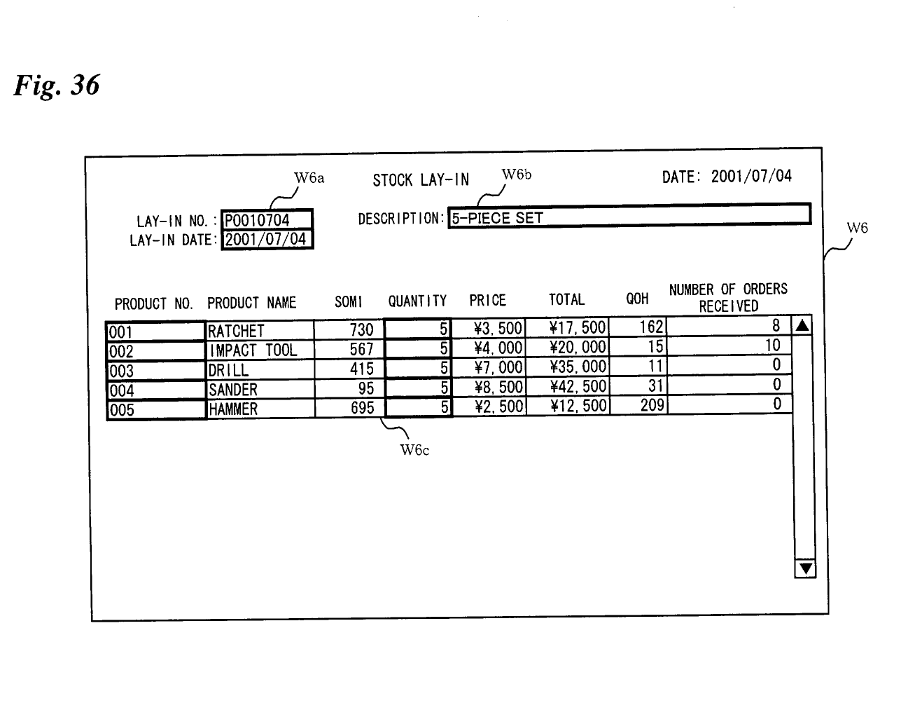

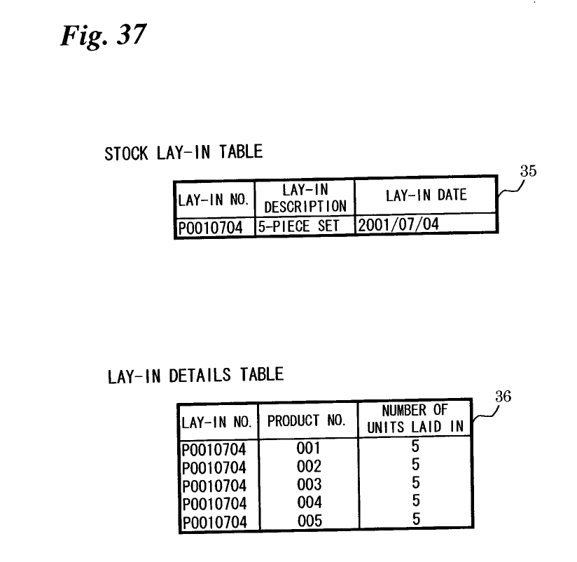

FIG. 35 is a flowchart illustrating processing executed by the server 2 and by a client (mainly the buyer client 4) in stock lay-in processing, as well as the flow of data transmission and reception. Stock lay-in processing is based upon the stock lay-in processing program that has been stored on the hard disk 16 of server 2. Stock lay-in processing based upon the stock lay-in program is processing for recording a track record of buyer lay-in of products from SOMI to QOH. FIG. 36 illustrates an example of a display presented on the display screen of the display unit of buyer client 4 based upon processing in accordance with the stock lay-in program. FIG. 37 illustrates examples of the stock lay-in table 35 and stock lay-in details table 36 used in purchasing processing.

Stock Lay-in Table 35 (FIG. 37)

The stock lay-in table 35 is provided with the following items: stock lay-in number, stock lay-in description and stock lay-in date.

“STOCK LAY-IN NO.” is a number assigned when a buyer moves a product in SOMI to QOH (this is referred to as “laying in stock”). A description pertaining to lay-in specified by the stock lay-in number is stored under “STOCK LAY-IN DESCRIPTION”, and the date (year, month and day) thereof is stored under “STOCK LAY-IN DATE”.

The stock lay-in details table 36 has the following items: stock lay-in number, product number and number laid in. The stock lay-in details table 36 and stock lay-in table 35 are linked by the stock lay-in number. The stock lay-in details table 36 and product master 21 (FIG. 12) are linked by the product number.

“NUMBER LAID IN” is the quantity laid in on a per-product basis.

Processing executed by the server 2 and buyer client 4 in stock lay-in processing will be described with reference to FIG. 35.

If the operator of the buyer client 4 enters a stock lay-in-program launch instruction from an input unit (step 151), the lay-in program is launched by the server 2. Data representing a stock lay-in screen is transmitted from the server 2 to the buyer client 4 (step 161). A stock lay-in screen W6 (FIG. 36) is displayed on the display screen of the buyer client 4 (step 152).

The stock lay-in screen W6 includes a lay-in number/lay-in date input field W6a, a description input field W6b and a lay-in content input and display field W6c. [In the initial state (step 152), no characters or numerals, etc. are displayed in any of the above-mentioned fields.] The user of the buyer client 4 enters the lay-in number of lay-in date in the lay-in number/lay-in date input field W6a and enters the product number of the lay-in product and the quantity of the lay-in product in the lay-in content input and display field W6c. If necessary, the description regarding the lay-in product is entered in the description input field W6b (step 153). The entered data is transmitted from the buyer client 4 to the server 2.

On the basis of the product number and quantity of this product transmitted from the buyer client 4, the server 2 refers to the product master 21 and calculates the monetary amount of stock lay-in [a figure obtained by multiplying the product unit price (“OFFERING PRICE” in FIG. 12] of every product laid in. The product name, product unit price (“OFFERING PRICE” in FIG. 12] and monetary amount of stock lay-in of every product are transmitted to the buyer client 4. Further, the server refers to the daily inventory status table 31 (FIG. 27), calculates the number of units in SOMI and number of units in QOH after the lay-in product has been laid in, and transmits the results to the buyer client 4. The number ordered stored in the daily inventory status table 31 also is transmitted to the buyer client 4 (step 162). The product name, number of units in SOMI, offering price, monetary amount (monetary amount of stock lay-in), number of units in QOH and number of orders are displayed in the lay-in content input and display field W6c (step 154).

If a case where the content being displayed on the display screen is revised, the product number and quantity of this product are entered again (“NO” at step 155; step 153).

If it is unnecessary to revise the content being displayed on the display screen and an input to this effect is made from the input unit (e.g., as by pressing a predetermined function key), the content of stock lay-in is finalized. The data is stored in the stock lay-in table 35 and stock lay-in details table 36 at the server 2 and the number of units in SOMI and number of units in QOH are updated in the daily inventory status table 31. (With regard to a lay-in product, the number of units obtained by subtracting the number laid in from the number of units in SOMI becomes a new number of units in SOMI. With regard to the number of units in QOH, the number of units obtained by adding on the number laid in becomes the new number of units in QOH.)

(6) Sales Processing

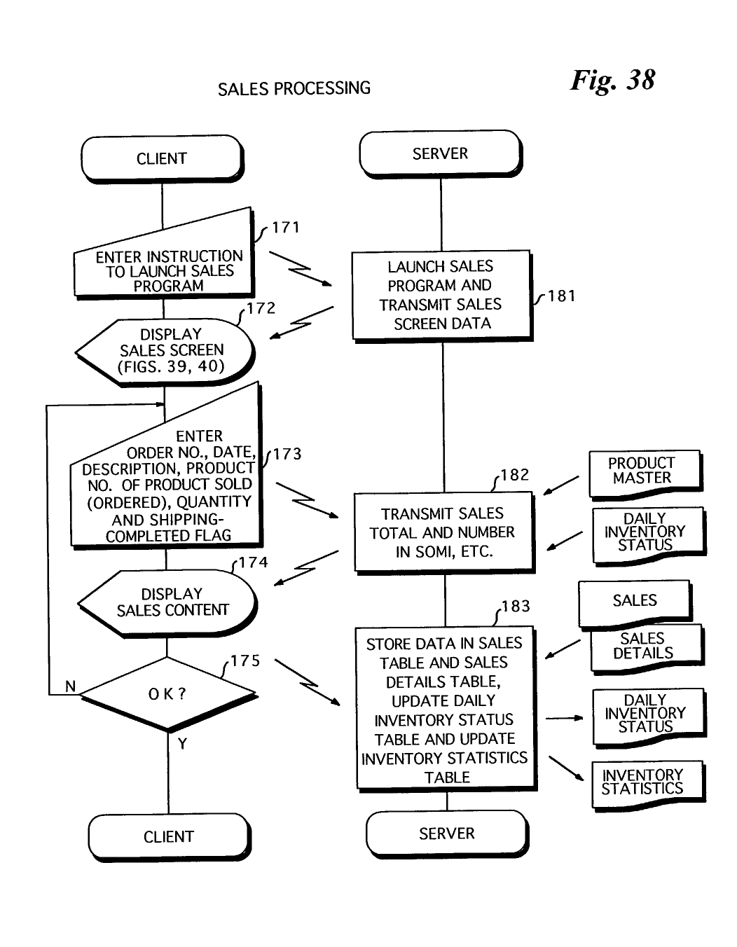

FIG. 38 is a flowchart illustrating processing executed by the server 2 and by a client (mainly the buyer client 4) in purchase processing, as well as the flow of data transmission and reception. Purchase processing is based upon the purchase program that has been stored on the hard disk 16 of server 2.

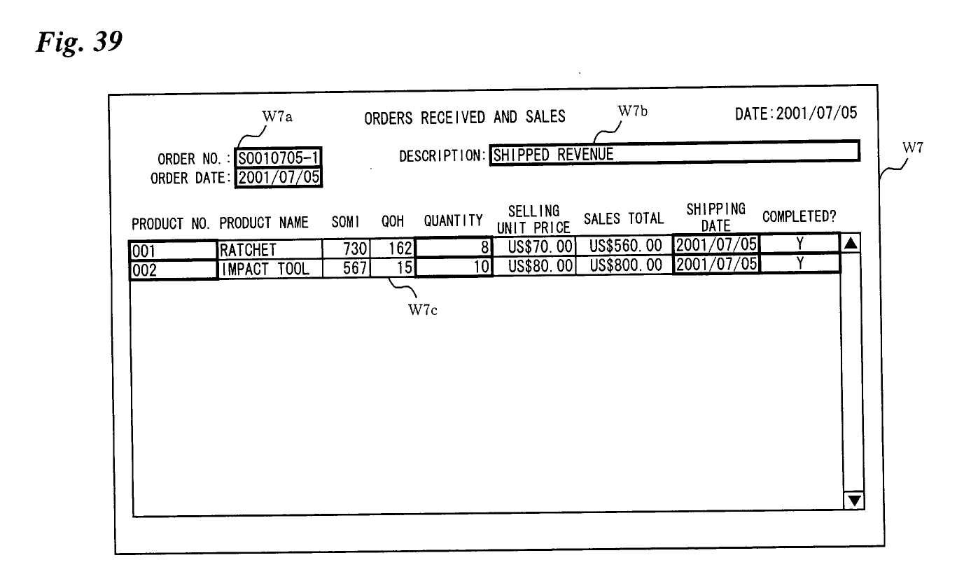

As described above, sales processing is processing for recording a track record of product allocation (receipt of orders) by the buyer and a track record of sales of the product by the buyer. A track record of sales, orders received and allocation of a product by the buyer is entered using a sales screen displayed on the display screen of the display unit of the buyer client 4 based upon the sales program executed by the server 2. FIG. 39 illustrates an example of a sale screen displayed on the display screen of the display unit of buyer client 4.

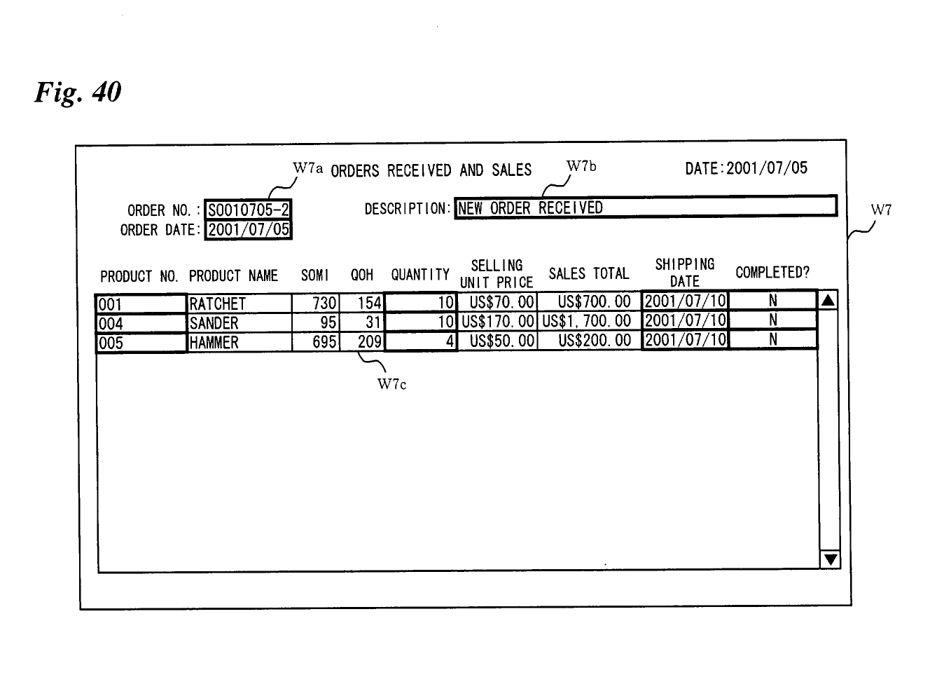

If the operator of the buyer client 4 enters a sales program launch instruction (step 171), sales program is launched by the server 2 and sales screen data is transmitted from the server 2 to the buyer client 4 (step 181). A received-order and sales screen W7 (FIGS. 39, 40) is displayed on the display screen of the buyer client 4.

The received-order and sales screen W7 includes an order number/order date input field W7a, a description input field W7b and a sales content input and display field W7c. The operator of the buyer client 4 enters an order number and order date in the order number/order date input field W7a, enters a description regarding sales (order) in the description input field W7b, and enters a product number of a product sold (ordered), the quantity thereof and the shipping date or scheduled shipping date in the sales content input and display field W7c (step 173).

The server 2 refers to the product master 21 (FIG. 12) and calculates the monetary sales amount by multiplying the product selling price (price when the product is sold) by the buyer to customers by the sales quantity.

The sales content input and display field W7c includes an input field for a shipping-completed flag. If shipping has been completed, “Y” is entered (FIG. 39). If an order has been received but not shipped, “N” is entered (FIG. 40).

If content being displayed on the display screen is revised, the product number of the product, the quantity thereof and the shipping date, etc., are entered again (“NO” at step 175; step 173). If it is unnecessary to revise the content being displayed on the display screen (“YES” at step 175) and an input to this effect is made from the input unit (e.g., as by pressing a predetermined function key), the content of the sale is finalized. The data is stored in the sales table 37 and sales details table 38 (FIG. 13) at the server 2 and the number of units in QOH is updated in the daily inventory status table 31. (With regard to a sold product, a figure obtained by subtracting the number of sales from the number of units in QOH is adopted as the new number of units in QOH (step 183).

(7) Financing Processing

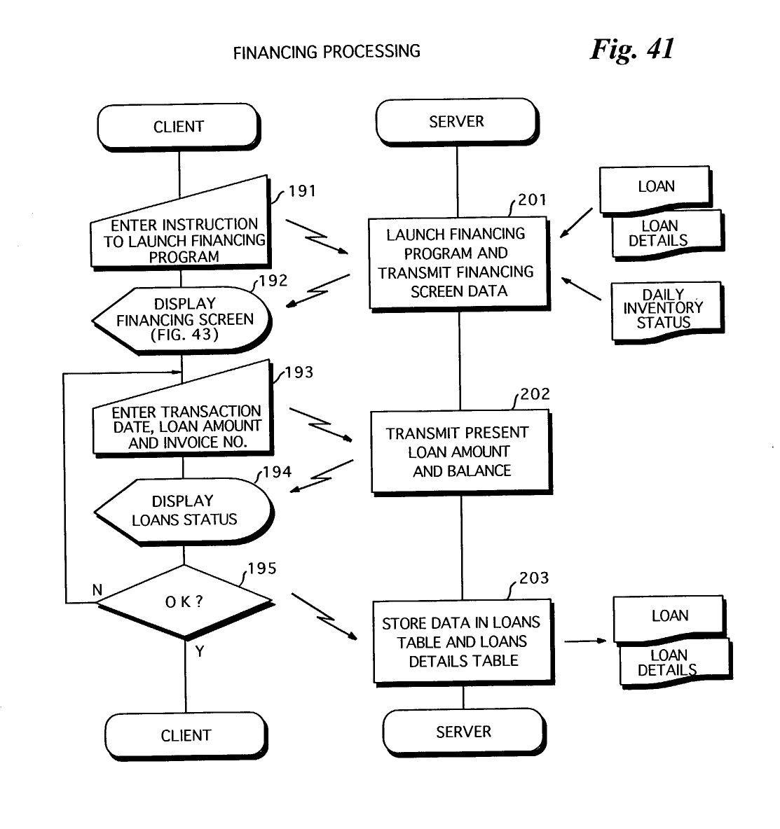

FIG. 41 is a flowchart illustrating processing executed by the server 2 and by the supplier client 3 in financing processing, as well as the flow of data transmission and reception. Financing processing is based upon a financing program that has been stored on the hard disk 16 of the server 2.

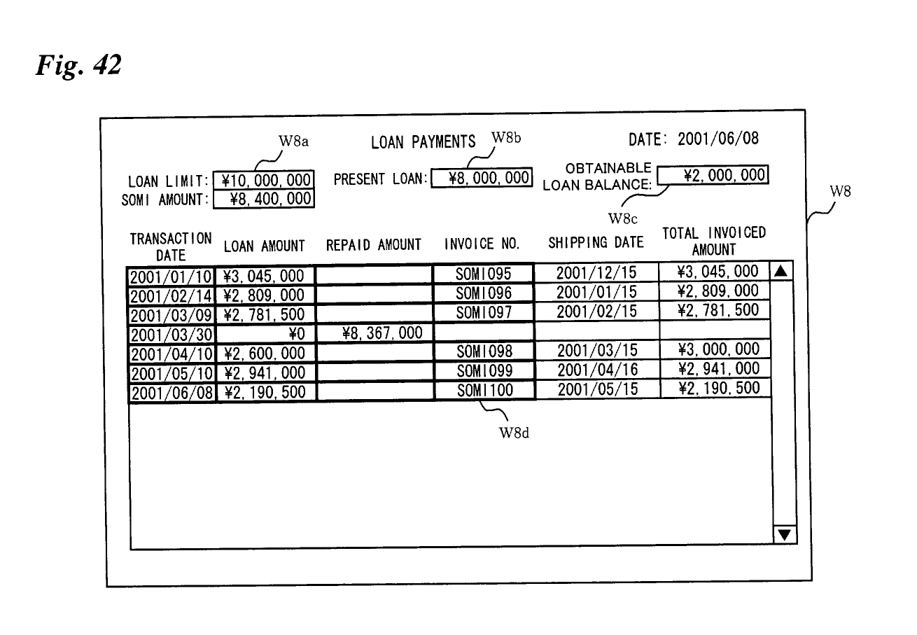

As mentioned above, financing processing is processing for recording a track record of loans and payments by the supplier. The track record of loans and payments by the supplier is entered using a financing screen displayed on the display unit of the supplier client 3 based upon the financing program executed by the server. FIG. 42 illustrates an example of a screen displayed on the display unit of the supplier client 3.

If the operator of the supplier client 3 enters a financing program launch instruction (step 191), the financing program is launched by the server 2 and financing screen data is transmitted from the server 2 to the supplier client 3 (step 201). A financing screen W8 (FIG. 42) is displayed on the display screen of the supplier client 3.

The financing screen W8 includes a loan limit/SOMI amount display field W8a, a present loan display field W8b, an obtainable loan balance display field W8c and a loan/repayment performance display input field W8d. The operator of the supplier client 3 enters a track record of loans from the negotiating bank [see FIG. 2(ix)] and a track record of loan payments [see FIG. 3(ix)] on the display screen.

In general, a supplier borrows money whenever a product is sent to a buyer. When the product is sent (shipped) from the supplier to the buyer, an invoice is issued (an invoice number is assigned) in conformity with each shipment. When the product arrives at the location of the buyer, the product that has arrived is inspected, etc., and the sum total of the sent product (the invoiced amount) is calculated (acceptance processing). In general, the supplier borrows, from the negotiating bank, an amount of money equivalent to the sum total (the invoiced amount) of the product sent to the buyer. The operator of the supplier client 3 enters the transaction date, the loan amount or amount of repayment and the invoice number in the loan/repayment performance display input field W8d (step 193).

The server 2 refers to the loans table 39 and loans details table 40 (FIG. 30) and calculates the present loan and obtainable loan balance using the loan amount or amount of repayment entered by the operator of the supplier client 3. That is, in the case of a loan, a sum obtained by adding the entered loan amount to the present loan is adopted as a new present loan and a sum obtained by subtracting the entered loan amount from the obtainable loan balance is adopted as a new obtainable loan balance. In the case of a loan repayment, a sum obtained by subtracting the entered amount of repayment from the present loan is adopted as a new present loan, and a sum obtained by adding the entered amount of repayment to the obtainable loan balance is adopted as a new obtainable loan balance.

The new present loan and the obtainable loan balance calculated are transmitted to the supplier client 3 (step 202) and displayed on the display screen of the supplier client 3 (step 194).

If the content being displayed on the display screen is to be revised, this transaction date and the amounts are entered again (“NO” at step 195; step 193). If it is unnecessary to revise the content being displayed on the display screen (“YES” at step 195) and an input to this effect is made from the input unit (e.g., as by pressing a predetermined function key), entry of loan/repayment status ends. Data representing the track record of loans/repayments is stored in the loans table 39 and loan details table 40 (FIG. 30) at the server 2 (step 203).

Forecast processing, shipping planning processing, shipping processing, acceptance processing, buy-up request processing, stock lay-in processing, sales processing and financing processing executed in the above-described system for supporting trade transactions is executed by the supplier or buyer or by both the supplier and buyer. However, the results of processing (results of execution) implemented through execution by the supplier can be viewed by the buyer (by perusing a screen), and the results of processing (results of execution) implemented through execution by the buyer can be viewed by the supplier (by perusing a screen). The supplier and buyer can share information relating to trade transactions. However, confidential information such as cost and selling price is not shared between the supplier and buyer.

By placing a product that the supplier supplies to the buyer at the location of the buyer while the right of ownership remains with the supplier (i.e., by utilizing SOMI), the buyer can respond immediately to a request from a consumer (a product purchase request) and, hence, there is no danger that inventory will be inadequate. Furthermore, by making the point of transfer of ownership the moment the buyer receives an order from a consumer, the buyer can cut down on the amount of stock in its own inventory (QOH). This means that the buyer can reduce inventory expense brought about by holding inventory and allows these funds to be utilized effectively. The end result is an improved balance sheet. As far as the supplier is concerned, the risk involved in supplying SOMI to a buyer is covered by a standby letter of credit and operating funds can be procured by the standby letter of credit. This makes it possible to stabilize management.

The programs for running the trade transaction support system (forecast program, shipping planning program, shipping program, acceptance program, buy-up request program, stock lay-in program, sales program and financing program) can be distributed by being recorded on a recording medium such as a CD-ROM or can be distributed over a network. Though the trade transaction support system described above is constituted by one server 2, one supplier client 3 and one buyer client 4, a plurality of supplier clients and buyer clients may be incorporated in the system. Furthermore, by having the server 2 store the tables of other suppliers and buyers in a transaction relationship on the hard disk 16, it is possible to construct a trade transaction support system regarding the other suppliers and buyers. This is a mode in which the server 2 is utilized cooperatively under the management of a third party.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for supporting trade transactions between a supplier who exports a product and a buyer who sells the imported product to a customer, comprising:
forecasting means for forecasting quantity of future sales by the buyer on a per-product basis based upon performance of sales to a customer by the buyer with regard to each product of a plurality of types;
first display data creating means for creating data for displaying the future sales quantity of every product forecast by said forecasting means;
export planning means for deciding types of products and quantities thereof, which the supplier is to export to the buyer, based upon the future sales quantity of every product forecast by said forecasting means; and
second display data creating means for creating data for displaying the types of products and quantities thereof to be exported decided by said export planning means.

2. The apparatus according to claim 1, further comprising storage means for storing data representing performance of sales by the buyer on a per-product basis, data representing future sales quantity of every product forecast by said forecasting means, and data representing the types of products and quantities thereof to be exported decided by said export planning means.

3. The apparatus according to claim 1, wherein said first display data creating means creates data for displaying performance of sales by the buyer on a per-product basis.

4. The apparatus according to claim 3, wherein said forecasting means forecasts future sales quantity by month, and said first display data creating means creates data for displaying future sales quantity by month and sales performance by month.

5. The apparatus according to claim 1, wherein said forecasting means obtains an equation representing a regression line, a regression quadratic curve or a regression exponential curve from the sales performance and finds the future sales quantity of every product based upon the equation obtained.

6. The apparatus according to claim 2, further comprising input means for accepting input of a revision of future sales quantity of every product displayed on a display screen by the data created by said first display data creating means;
wherein said export planning means decides types of products and quantities thereof to be exported based upon revised values accepted by said first input means, and said storage means.stores a revised value, which has been accepted by said first input means, regarding the future sales quantity of every product.

7. The apparatus according to claim 1, wherein said second display data creating means also creates data for displaying the quantity of each product in supplier inventory, which is inventory wherein the products are under the management of the buyer and, moreover, in the ownership of the supplier, and the quantity of each product in buyer inventory, which is inventory wherein the products are under the management of the buyer and, moreover, whose right of ownership has been transferred from the supplier to the buyer so that the products are in the ownership of the buyer.

8. The apparatus according to claim 7, wherein said export planning means decides the quantity of a product to be exported in such a manner that an available-to-promise quantity will not fall below a predetermined quantity, wherein the available-to-promise quantity is the sum total of the quantity of supplier inventory, the quantity of buyer inventory and a quantity of in-transit inventory regarding a product to be exported.

9. The apparatus according to claim 8, further comprising predicted available-to-promise quantity calculation means for calculating the available-to-promise quantity at a scheduled export date by the supplier;
wherein said export planning means calculates the quantity of a product to be exported in such a manner that the available-to-promise quantity calculated by said predicted available-to-promise quantity calculation means will not fall below a predetermined quantity.

10. The apparatus according to claim 2, further comprising second input means for accepting input of a revision of quantity of a product to be exported displayed on a display screen by the data created by said second display data creating means;
wherein said storage means stores a revised value, which has been accepted by said second input means, regarding the quantity of a product to be exported.

11. An apparatus for supporting trade transactions between a supplier who exports a product and a buyer who sells the imported product to a customer, comprising:
first storage means for storing quantity, supplier buy-up request intent data and buyer buy-up intent data of each product in supplier inventory, which is inventory wherein the products are under the management of the buyer and, moreover, in the ownership of the supplier;
determination means for determining whether the total monetary amount of a product in the supplier inventory is greater than a predetermined limit amount;
buy-up product decision means which, if said determination means has determined that the total monetary amount of a product in the supplier inventory is greater than the limit amount, is for deciding a product and the quantity thereof that the buyer is to be made to buy in such a manner that a buy-up amount of the product by the buyer will become equal to or greater than an amount obtained by subtracting the limit amount from the total monetary amount of the product, this decision being rendered based upon the supplier buy-up request intent data and buyer buy-up intent data; and
display data creation means for creating data for displaying the type of product and quantity thereof decided by said buy-up product decision means.

12. The apparatus according to claim 11, wherein said buy-up product decision means alternatingly executes a decision concerning the type of a product and the quantity thereof based upon buyer buy-up intent data and a decision concerning the type of a product and the quantity thereof based upon supplier buy-up request intent data.

13. The apparatus according to claim 11, further comprising second storage means for storing statistical data relating to available-to-promise number of turns, gross margin, revenue and number of turns in supplier inventory of every product in supplier inventory;
wherein on the basis of the statistical data that has been stored in said second storage means, said buy-up product decision means decides the type of a product and the quantity thereof that the buyer is to be made to buy, in accordance with the buyer buy-up intent data and supplier buy-up request intent data.

14. An apparatus for supporting trade transactions between a supplier who exports a product and a buyer who sells the imported product to a customer, comprising:
first storage means for storing a quantity of each type of product in supplier inventory, which is inventory wherein the products are under the management of the buyer and, moreover, in the ownership of the supplier, a quantity of each type of product in buyer inventory, which is inventory wherein the products are under the management of the buyer and, moreover, whose right of ownership has been transferred from the supplier to the buyer so that the products are in the ownership of the buyer, and quantity of each type of product in transit from the supplier to the buyer; and
display data creating means for creating data for displaying the quantity of each type of product in supplier inventory, the quantity of each type of product in buyer inventory and the quantity of each type of product in transit from the supplier to the buyer, these quantities having been stored in said storage means.

15. The apparatus according to claim 14, further comprising second storage means for storing a scheduled arrival data of a product in transit from the supplier to the buyer.

16. A method of supporting trade transactions between a supplier who exports a product and a buyer who sells the imported product to a customer, comprising the steps of:
forecasting a future quantity of sales by the buyer on a per-product basis based upon performance of sales to a customer by the buyer with regard to each product of a plurality of types;
creating data for displaying the forecast future sales quantity of every product;
deciding types of products and quantities thereof, which the supplier is to export to the buyer, based upon the forecast future sales quantity of every product; and
creating data for displaying the decided types of products and quantities thereof to be exported.

17. The method according to claim 16, further comprising a step of storing data representing performance of sales by the buyer on a per-product basis, data representing forecasted future sales quantity of every product, and data representing the types of products and quantities thereof to be exported that have been decided.

18. The method according to claim 16, further comprising steps of:
obtaining an equation representing a regression line, a regression quadratic curve or a regression exponential curve from the sales performance; and
finding the future sales quantity of every product based upon the equation obtained.

19. The method according to claim 16, further comprising a step of creating data for displaying the quantity of each product in supplier inventory, which is inventory wherein the products are under the management of the buyer and, moreover, in the ownership of the supplier, and the quantity of each product in buyer inventory, which is inventory wherein the products are under the management of the buyer and, moreover, whose right of ownership has been transferred from the supplier to the buyer so that the products are in the ownership of the buyer.

20. The method according to claim 19, further comprising a step of deciding the quantity of a product to be exported in such a manner that an available-to-promise quantity will not fall below a predetermined quantity, wherein the available-to-promise quantity is the sum total of the quantity of supplier inventory, the quantity of buyer inventory and a quantity of in-transit inventory regarding a product to be exported.

21. The method according to claim 20, further comprising steps of:
calculating the available-to-promise quantity at a scheduled export date by the supplier; and
calculating the quantity of a product to be exported in such a manner that the available-to-promise quantity will not fall below a predetermined quantity.

22. A method of supporting trade transactions between a supplier who exports a product and a buyer who sells the imported product to a customer, comprising the steps of:
storing quantity, supplier buy-up request intent data and buyer buy-up intent data of each product in supplier inventory, which is inventory wherein the products are under the management of the buyer and, moreover, in the ownership of the supplier;
determining whether the total monetary amount of a product in the supplier inventory is greater than a predetermined limit amount;
if it has been determined that the total monetary amount of a product in the supplier inventory is greater than the limit amount, deciding a product and the quantity thereof that the buyer is to be made to buy in such a manner that a buy-up amount of the product by the buyer will become equal to or greater than an amount obtained by subtracting the limit amount from the total monetary amount of the product, this decision being rendered based upon the supplier buy-up request intent data and buyer buy-up intent data; and
creating data for displaying the type of product and quantity thereof decided.

23. The method according to claim 22, further comprising a step of deciding a type of product and the quantity thereof that the buyer is to be made to buy by alternatingly executing a decision concerning the type of a product and the quantity thereof based upon buyer buy-up intent data and a decision concerning the type of a product and the quantity thereof based upon supplier buy-up request intent data.

24. The method according to claim 22, further comprising steps of:
storing statistical data relating to available-to-promise number of turns, gross margin, revenue and number of turns in supplier inventory of every product in supplier inventory; and
on the basis of the statistical data, deciding the type of a product and the quantity thereof that the buyer is to be made to buy, in accordance with the buyer buy-up intent data and supplier buy-up request intent data.

25. A computer readable recording medium having a program recorded thereon for controlling a computer that supports trade transactions between a supplier who exports a product and a buyer who sells the imported product to a customer, said program causing the computer to execute the following processing:
forecast processing for forecasting quantity of future sales by the buyer on a per-product basis based upon performance of sales to a customer by the buyer with regard to each product of a plurality of types;
first display data creation processing for creating data for displaying the forecast future sales quantity of every product;
export planning processing for deciding types of products and quantities thereof, which the supplier is to export to the buyer, based upon the forecast future sales quantity of every product; and
second display data creation processing for creating data for displaying the decided types of products and quantities thereof to be exported.

26. The computer readable recording medium according to claim 25, wherein said forecast processing obtains an equation representing a regression line, a regression quadratic curve or a regression exponential curve from the sales performance, and finds the future sales quantity of every product based upon the equation obtained.

27. The computer readable recording medium according to claim 25, wherein said program causes the computer to execute third display data creation processing for displaying the quantity of each product in supplier inventory, which is inventory wherein the products are under the management of the buyer and, moreover, in the ownership of the supplier, and the quantity of each product in buyer inventory, which is inventory wherein the products are under the management of the buyer and, moreover, whose right of ownership has been transferred from the supplier to the buyer so that the products are in the ownership of the buyer.

28. The computer readable recording medium according to claim 27, wherein said export planning processing decides the quantity of a product to be exported in such a manner that an available-to-promise quantity will not fall below a predetermined quantity, wherein the available-to-promise quantity is the sum total of the quantity of supplier inventory, the quantity of buyer inventory and a quantity of in-transit inventory regarding a product to be exported.

29. The computer readable recording medium according to claim 28, wherein said program causes the computer to execute predicted available-to-promise quantity calculation processing for calculating the available-to-promise quantity at a scheduled export date by the supplier; and
said export planning processing calculates the quantity of a product to be exported in such a manner that the available-to-promise quantity calculated by said predicted available-to-promise quantity calculation processing will not fall below a predetermined quantity.

30. A computer readable recording medium having a program recorded thereon for controlling a computer that supports trade transactions between a supplier who exports a product and a buyer who sells the imported product to a customer, said program causing the computer to execute the following processing:
determination processing for determining whether the total monetary amount of a product in supplier inventory, which is inventory wherein the products are under the management of the buyer and, moreover, in the ownership of the supplier, is greater than a predetermined limit amount;
first storage processing for storing supplier buy-up request intent data and buyer buy-up intent data that has been accepted; and
decision processing which, if it has been determined that the total monetary amount of a product in the supplier inventory is greater than the limit amount, is for deciding a product and the quantity thereof that the buyer is to be made to buy in such a manner that a buy-up amount of the product by the buyer will become equal to or greater than an amount obtained by subtracting the limit amount from the total monetary amount of the product, this decision being rendered based upon the supplier buy-up request intent data and buyer buy-up intent data; and
display data creation processing for creating data for displaying the type of product and quantity thereof decided.

31. The computer readable recording medium according to claim 30, wherein said decision processing decides a type of product and the quantity thereof that the buyer is to be made to buy by alternatingly executing a decision concerning the type of a product and the quantity thereof based upon buyer buy-up intent data and a decision concerning the type of a product and the quantity thereof based upon supplier buy-up request intent data.

32. The computer readable recording medium according to claim 30, wherein said program causes the computer to further execute second storage processing for storing statistical data relating to available-to-promise number of turns, gross margin, revenue and number of turns in supplier inventory of every product in supplier inventory; and
on the basis of the statistical data, said decision processing decides the type of a product and the quantity thereof that the buyer is to be made to buy, in accordance with the buyer buy-up intent data and supplier buy-up request intent data.

33. In a system, which comprises a server and a client connected together via a network, for supporting trade transactions between a supplier who exports a product and a buyer who sells the imported product to a customer, said server comprises:
forecasting means for forecasting quantity of future sales by the buyer on a per-product basis based upon performance of sales to a customer by the buyer with regard to each product of a plurality of types, a signal representing said performance being transmitted from the client;
export planning means for deciding types of products and quantities thereof, which the supplier is to export to the buyer, based upon the future sales quantity of every product forecast by said forecasting means; and
transmitting means for transmitting, to the client, data representing the future sales quantity of every product forecast by said forecasting means and data representing the types of products and quantities thereof to be exported decided by said export planning means.

34. In a system, which comprises a server and a client connected together via a network, for supporting trade transactions between a supplier who exports a product and a buyer who sells the imported product to a customer, said client comprises:
input means for accepting input of performance of sales to a customer by the buyer with regard to each product of a plurality of types;
transmitting means for transmitting the sales performance, which has been accepted by said input means, to the server;
first receiving means for receiving data representing the future quantity of sales of every product by the user forecast by the server based upon the sales performance;
first display means for displaying the future sales quantity of every product represented by data representing the future sales quantity of every product received by said first receiving means;
second receiving means for receiving data representing types of products and quantities thereof, which the supplier is to export to the buyer, decided based upon the future sales quantity of every product forecast by the server; and
second display means for displaying the types of products and quantities thereof to be exported represented by the data representing the types of products and quantities thereof to be exported received by said second receiving means.

35. In a system, which comprises a server and a client connected together via a network, for supporting trade transactions between a supplier who exports a product and a buyer who sells the imported product to a customer, a method of controlling said server, comprising:
forecasting future quantity of sales by the buyer on a per-product basis based upon performance of sales to a customer by the buyer with regard to each product of a plurality of types, a signal representing said performance being transmitted from the client;
deciding types of products and quantities thereof, which the supplier is to export to the buyer, based upon the forecast future sales quantity of every product; and
transmitting, to the client, data representing the future sales quantity of every product and data representing the types of products and quantities thereof to be exported.

36. In a system, which comprises a server and a client connected together via a network, for supporting trade transactions between a supplier who exports a product and a buyer who sells the imported product to a customer, a method of controlling said client, comprising:
accepting input of performance of sales to a customer by the buyer with regard to each product of a plurality of types;
transmitting the accepted sales performance to the server;
receiving data representing the future quantity of sales of every product by the user forecast by the server based upon the sales performance;
displaying the future sales quantity of every product represented by data representing the received future sales quantity of every product;
receiving data representing types of products and quantities thereof, which the supplier is to export to the buyer, decided based upon the future sales quantity of every product forecast by the server; and
displaying the types of products and quantities thereof to be exported represented by the received data representing the types of products and quantities thereof to be exported.

37. In a system, which comprises a server and a client connected together via a network, for supporting trade transactions between a supplier who exports a product and a buyer who sells the imported product to a customer, said server comprises:
storage means for storing the quantity of each product in supplier inventory, which is inventory wherein the products are under the management of the buyer and, moreover, in the ownership of the supplier, supplier buy-up request intent data and buyer buy-up intent data;
determination means for determining whether the total monetary amount of a product in the supplier inventory is greater than a predetermined limit amount;
decision means which, if said determination means has determined that the total monetary amount of a product in the supplier inventory is greater than the limit amount, is for deciding a product and the quantity thereof that the buyer is to be made to buy in such a manner that a buy-up amount of the product by the buyer will become equal to or greater than an amount obtained by subtracting the limit amount from the total monetary amount of the product, this decision being rendered based upon the supplier buy-up request intent data and buyer buy-up intent data; and
transmitting means for transmitting, to the client, data representing the type of product and quantity thereof decided by said decision means.

38. In a system, which comprises a server and a client connected together via a network, for supporting trade transactions between a supplier who exports a product and a buyer who sells the imported product to a customer, a method of controlling said server, comprising:
storing the quantity of each product in supplier inventory, which is inventory wherein the products are under the management of the buyer and, moreover, in the ownership of the supplier, supplier buy-up request intent data and buyer buy-up intent data;
determining whether the total monetary amount of a product in the supplier inventory is greater than a predetermined limit amount;
if it has been determined that the total monetary amount of a product in the supplier inventory is greater than the limit amount, deciding a product and the quantity thereof that the buyer is to be made to buy in such a manner that a buy-up amount of the product by the buyer will become equal to or greater than an amount obtained by subtracting the limit amount from the total monetary amount of the product, this decision being rendered based upon the supplier buy-up request intent data and buyer buy-up intent data; and
transmitting, to the client, data representing the type of product and quantity thereof decided.

39. A method of performing trade transactions, comprising the steps of:
placing a product, which is exported by the supplier and imported by the buyer, under the management of the buyer with ownership of the product being retained by the supplier; and
based upon the standby letter of credit issued in accordance with a request from the buyer, having the supplier raise funds needed to keep in inventory a product that is under the management of the buyer.

40. A method of performing trade transactions between a supplier who exports a product and a buyer who imports the product, comprising the steps of:
placing a product, which is exported by the supplier and imported by the buyer, under the management of the buyer with ownership of the product being retained by the supplier;
having the buyer request a collection bank to issue a standby letter of credit;
having the collection bank that has received the request for issuance of the standby letter of credit request a reimbursing bank to issue the standby letter of credit;
having the reimbursing bank that has issued the standby letter of credit forward the standby letter of credit to a negotiating bank and notify the supplier of the content of the standby letter of credit; and
in accordance with the credit based upon the standby letter of credit, having the supplier borrow, from the negotiating bank, funds needed to keep in inventory a product that is under the management of the buyer.

41. The method according to claim 39, further comprising the steps of:
transferring right of ownership of a product, which is under the management of the buyer and the right of ownership of which is held by the supplier, from the supplier to the buyer; and
having the buyer respond to an order from a customer by selling to the customer the product whose right of ownership has been transferred to the buyer.

42. The method according to claim 39, further comprising a step of managing by computer the total of stock of every type of product, which is under the management of the buyer and the right of ownership of which is held by the supplier, stock of every type of product, which is under the management of the buyer and the right of ownership of which is held by the buyer owing to transfer of the right of ownership, and the number of every type of product currently in transit from the supplier to the buyer.

43. The method according to claim 39, further comprising the steps of:
forecasting future sales quantity of every type of product based upon results of sales of the product to customers by the buyer; and
deciding the type of product and the quantity thereof is supplied to the buyer from the supplier, in accordance with the total of stock of every type of product, which is under the management of the buyer and the right of ownership of which is held by the supplier, stock of every type of product, which is under the management of the buyer and the right of ownership of which is held by the buyer owing to transfer of the right of ownership, the number of every type of product currently in transit from the supplier to the buyer, and the forecasted future sales quantity of every product to be sold by the buyer.

44. The method according to claim 42, further comprising a step of having the supplier use a computer to forecast future sales quantity of every product based upon results of sales of the product to customers by the buyer, and decide by computer the type of product and the quantity thereof to be exported, taking into consideration the sales quantity obtained by the forecast.

45. The method according to claim 40, wherein if the monetary amount of a product the right of ownership of which is held by the supplier and that is under the management of the buyer exceeds an amount that can be borrowed on the standby letter of credit, the supplier requests the buyer to buy the product in an amount commensurate with the excess.

46. The method according to claim 45, wherein the type of product and the quantity thereof to be bought by the buyer are decided taking into consideration the opinions of both the supplier and buyer.

47. The method according to claim 43, further comprising a step of disclosing on computers owned by the supplier and the buyer the total of stock of every type of product, which is under the management of the buyer and the right of ownership of which is held by the supplier, stock of every type of product, which is under the management of the buyer and the right of ownership of which is held by the buyer owing to transfer of the right of ownership, the number of every type of product currently in transit from the supplier to the buyer, the forecasted future sales quantity of every product to be sold by the buyer, and the decided type of product and the quantity thereof to be supplied from the supplier to the buyer.
